(19) United States
(12) Patent Application Publication
(10) Pub. No.: US 2016/0250743 A1
(43) Pub. Date: Sep. 1, 2016

(54) ELECTRICAL POWER TOOL

(71) Applicant: HITACHI KOKI CO., LTD., Minato-ku, Tokyo (JP)

(72) Inventors: Hajime KIKUCHI, Ibaraki (JP); Takuya YOSHINARI, Ibaraki (JP); Toshiaki KOIZUMI, Ibaraki (JP)

(21) Appl. No.: 15/032,283

(22) PCT Filed: Nov. 17, 2014
(86) PCT No.: PCT/JP2014/005761

§ 371 Date: Apr. 26, 2016

(30) Foreign Application Priority Data
Nov. 26, 2013 (JP) 2013-243617
Feb. 28, 2014 (JP) 2014-037914

(51) Int. Cl. B25F 5/02; B25B 21/00; B25D 17/00; B25F 5/00

(52) U.S. Cl. CPC B25F 5/02; B25F 5/008; B25B 21/00; B25D 17/00; B25D 2250/095; B25D 2250/121; B25D 2250/245

(57) ABSTRACT

An electrical power tool capable of suppressing increase in a size of a device main body in a radial direction of an electrical motor is provided. A driver which drives a distal end tool with a power of an electrical motor includes: a casing in which the electrical motor is provided; a driven gear and a spindle which are arranged eccentrically with respect to an output shaft of the electrical motor and which transmit power of the output shaft to the distal end tool; and a power supply circuit unit arranged inside the casing. And, an arrangement region of the driven gear and the spindle and an arrangement region of the power supply circuit unit are at least partially overlapped with each other in a circumferential direction centering the output shaft.

### TECHNICAL FIELD

This invention relates to an electrical power tool that transmits a power of an electrical motor to a work tool through a power transmitting member.

### BACKGROUND ART

An electrical power tool designed to transmit the power of the electrical motor to the work tool through the power transmitting member is conventionally known, and Patent Literatures 1 and 2 describe an example of such an electrical power tool. The electrical power tool described in Patent Literature 1 is a driver, and the driver includes a housing serving as a device main body. An electrical motor is provided inside the housing, and a drive gear is provided on an output shaft of the electrical motor. A power transmitting shaft is rotatably provided inside the housing, and the power transmitting shaft is provided eccentrically with respect to the output shaft. A driven gear is formed on the power transmitting shaft, and the driven gear meshes with the drive gear.

A spindle is attached to the power transmitting shaft, and a driver bit serving as a work tool is held by the spindle. A grip is provided on the housing, so that an operator grips the grip. A trigger is provided on the grip, and a cord is connected to an end of the grip. A power supply circuit, a control circuit, and others are provided in the grip, so that an alternating-current power supply is supplied to the electrical motor through the cord when the operator operates the trigger, and thus, the output shaft is rotated. A torque of the output shaft is transmitted to the power transmitting shaft through the drive gear and the driven gear, and a torque of the power transmitting shaft is transmitted to the driver bit through the spindle.

Meanwhile, the electrical power tool described in Patent Literature 2 is an impact driver, and the impact driver includes a housing serving as a device main body. An electrical motor is provided in the housing, and an output shaft of the electrical motor, a speed reducing mechanism, a hammer, an anvil, and others are coaxially provided. A driver bit is attached to the anvil as a work tool. A grip extended in a direction intersecting an axis line of the electrical motor is connected to the housing, and a cord is attached to a distal end of the grip. A power supply circuit, a control circuit, and others are provided inside the grip, and a trigger is provided on the grip.

An electrical power tool having an electrical motor as a power source is conventionally known, and such an electrical power tool is described in Patent Literature 3. The electrical power tool described in Patent Literature 3 is an impact driver, and the impact driver includes a housing serving as a device main body, and the housing includes a tubular body portion and a grip continued to the body portion. In the body portion, the electrical motor, a speed reducing device to which the power of the electrical motor is transmitted, and others are provided. An anvil is supported by the body portion, and a distal end tool is attachable to the anvil. Furthermore, in the body portion, a hammer that transmits the power transmitted through the speed reducing device to the anvil is provided. Meanwhile, in the body portion, an inverter circuit substrate is provided, so that a switching element for turning ON and OFF a circuit that supplies a power to a coil of the electrical motor is attached to the inverter circuit substrate.

A substrate accommodating unit is provided at an end of the grip opposite to the body portion, and a control substrate and a power supply substrate are provided in the substrate accommodating unit. A lead wire that connects the power supply substrate and the inverter circuit substrate is provided, and the lead wire is provided in the grip. A microcomputer is provided on the control substrate, and a control signal is output from the microcomputer so that the switching element is turned ON/OFF by the control signal.

Here, although not described in Patent Literature 3, a signal transmission path for transmitting the control signal to the switching element is provided. In the grip, a choke coil, a capacitor, and others connected to the power supply substrate are provided, and a switching mechanism connected to the trigger is provided. Thus, the signal transmission path connecting the microcomputer provided on the control substrate and the switching element provided on the inverter circuit substrate is formed by a lead wire having flexibility, and such a lead wire is assumed to be provided in the grip.

### CITATION LIST

### Patent Literature

### [PTL 1]

### Japanese Patent Application Laid-Open Publication No. 2008-149437

### [PTL2]

### Japanese Patent Application Laid-Open Publication No. 2012-139749

### [PTL3]

### Japanese Patent Application Laid-Open Publication No. 2012-139747

### SUMMARY OF INVENTION

### Technical Problem

However, in both Patent Literatures 1 and 2, there is a problem of increase in a size of the device main body in a radial direction of the electrical motor since the electrical components such as the power supply circuit for supplying power to the electrical motor, the control circuit, and others are provided in the grip.

In the impact driver described in Patent Literature 3, if the lead wire connecting the control substrate and the inverter circuit substrate is provided in the grip, a path where the lead wire is provided becomes long, and therefore, a problem of complication of a structure of the impact driver arises.

An object of the present invention is to provide an electrical power tool capable of suppressing the increase in the size of the device main body in the radial direction of the electrical motor.

Also, another object of the present invention is to simplify the structure of the electrical power tool.

### Solution to Problem

An electrical power tool according to one embodiment is an electrical power tool that drives a work tool with a power of an electrical motor, the electrical power tool includes: a device main body having the electrical motor provided thereon; a power transmitting mechanism that is provided eccentrically with respect to an output shaft of the electrical motor and that transmits power of the output shaft to the work tool; and an electrical component provided inside the device main body, an arrangement region of the power transmitting mechanism and an arrangement region of the electrical component are at least partially overlapped with each other in a circumferential direction centering the output shaft.

An electrical power tool according to another embodiment is an electrical power tool that drives a work tool with a power of an electrical motor, the electrical power tool includes: a motor accommodation space in which the electrical motor is accommodated; a first accommodation space that is positioned on an outer side in a radial direction of the electrical motor and that accommodates a power supply circuit; a second accommodation space that is positioned on a side opposite to the first accommodation space in the radial direction of the electrical motor and that accommodates a control circuit for controlling the electrical motor; a first wall unit that partitions the motor accommodation space and the first accommodation space; and a second wall unit that partitions the motor accommodation space and the second accommodation space, and at least one of a first connection hole that is formed in the first wall unit and that connects the motor accommodation space and the first accommodation space or a second connection hole that is formed in the second wall unit and that connects the motor accommodation space and the second accommodation space is provided.

An electrical power tool according to still another embodiment is an electrical power tool that drives a work tool with a power of an electrical motor including a rotatable output shaft centering an axis line, and the electrical power tool includes: a motor accommodation space in which the electrical motor is accommodated; a substrate accommodation space that is positioned on an outer side of the electrical motor in a radial direction centering the axis line and that accommodates a circuit substrate for controlling the electrical motor; a device main body having the motor accommodation space and the substrate accommodation space formed therein; and a vent hole that is provided in the device main body and that connects an inside and an outside of the device main body.

An electrical power tool according to still another embodiment is an electrical power tool that supplies a power to an electrical motor, the electrical power tool includes: a first substrate provided with an electrical component that controls the power to be supplied to the electrical motor; a second substrate provided with a control circuit that controls the electrical component; a first connector provided on the first substrate and connected to the electrical component; and a second connector engaged and connected to the first connector and provided on the second substrate so as to be connected to the control circuit.

An electrical power tool according to still another embodiment is an electrical power tool that supplies a power to an electrical motor, and the electrical power tool includes: a first substrate provided with an electrical component that controls the power to be supplied to the electrical motor and that is attached to the electrical motor; a second substrate including a control circuit that controls the electrical component; a first connector that is provided on the first substrate and that is connected to the electrical component; a second connector that is provided on the second substrate and that is connected to the control circuit; a case that accommodates the second substrate; and a connecting unit that is provided in the case and that positions the case in the electrical motor.

### Advantageous Effects of Invention

According to the electrical power tool of the present invention, increase in a size of the device main body in the radial direction of the electrical motor can be suppressed.

In the electrical power tool of the present invention, the first connector and the second connector are engaged with and directly connected to each other, and therefore, a connecting element for indirectly connecting the first connector and the second connector, such as a lead wire, is unnecessary. Therefore, the electrical power tool can be simplified.

### BRIEF DESCRIPTION OF DRAWINGS

FIG. 1 is a plan view showing a driver according to a first embodiment of an electrical power tool;

FIG. 2 is a front view of the driver of FIG. 1;

FIG. 3 is a front cross-sectional view of the driver of FIG. 1;

FIG. 4 is a side cross-sectional view of the driver of FIG. 3, which has been cut in a motor housing;

FIG. 5 is a schematic view showing a connection relation among electrical elements of the driver of FIG. 1;

FIG. 6 is a block diagram showing a control system of the driver of FIG. 1;

FIG. 7 is a front cross-sectional view showing flow of air in a casing of the driver of FIG. 1;

FIG. 8 is a front cross-sectional view showing a driver according to a second embodiment of the electrical power tool;

FIG. 9 is a side cross-sectional view of the driver of FIG. 8, which has been cut in a connecting unit;

FIG. 10 is a front cross-sectional view showing flow of air in a casing of the driver of FIG. 8;

FIG. 11 is a front cross-sectional view showing a driver according to a third embodiment of the electrical power tool;

FIG. 12 is a side cross-sectional view of the driver of FIG. 11, which has been cut in a motor housing;

FIG. 13 is a front cross-sectional view showing flow of air in a casing of the driver of FIG. 11;

FIG. 14 is a front cross-sectional view showing a driver according to a fourth embodiment of the electrical power tool;

FIG. 15 is a front cross-sectional view showing flow of air in a casing of the driver of FIG. 14;

FIG. 16 is a front cross-sectional view showing a driver according to a fifth embodiment of the electrical power tool;

FIG. 17 is a front cross-sectional view showing a driver according to a sixth embodiment of the electrical power tool;

FIG. 18 is a cross-sectional view showing a principal part of the driver of FIG. 17;

FIGS. 19A and 19B are cross-sectional views of an accommodation case shown in FIG. 18;

FIG. 20A is a plan view of the accommodation case shown in FIG. 18, and FIG. 20B is a bottom view of the accommodation case shown in FIG. 18;

FIG. 21A is a left side view of the accommodation case shown in FIG. 18, and FIG. 21B is a right side view of the accommodation case shown in FIG. 18;

FIGS. 22A and 22B are side cross-sectional views of the driver shown in FIG. 17;

FIG. 23 is a block diagram showing a control system of the driver of FIG. 17; and

FIG. 24 is a schematic front view showing another arrangement example of the accommodation case for the casing.

### DESCRIPTION OF EMBODIMENTS

Hereinafter, embodiments of the present invention will be described in detail based on the drawings.

### First Embodiment

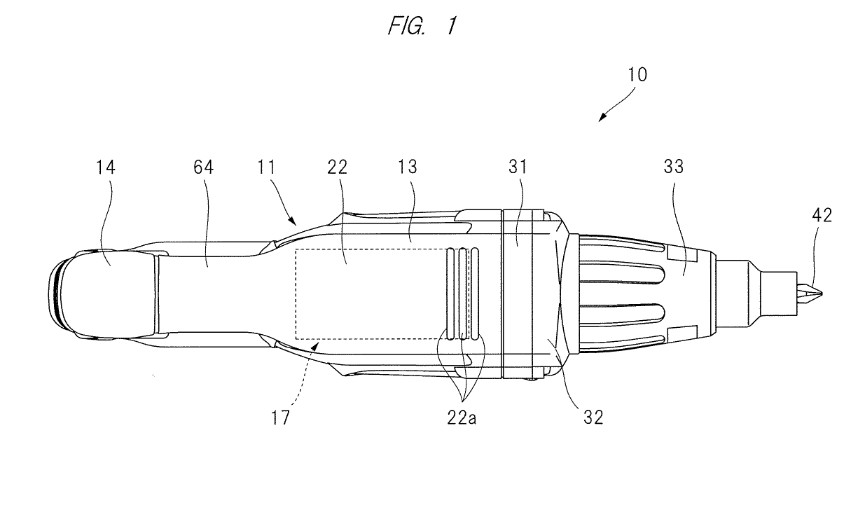

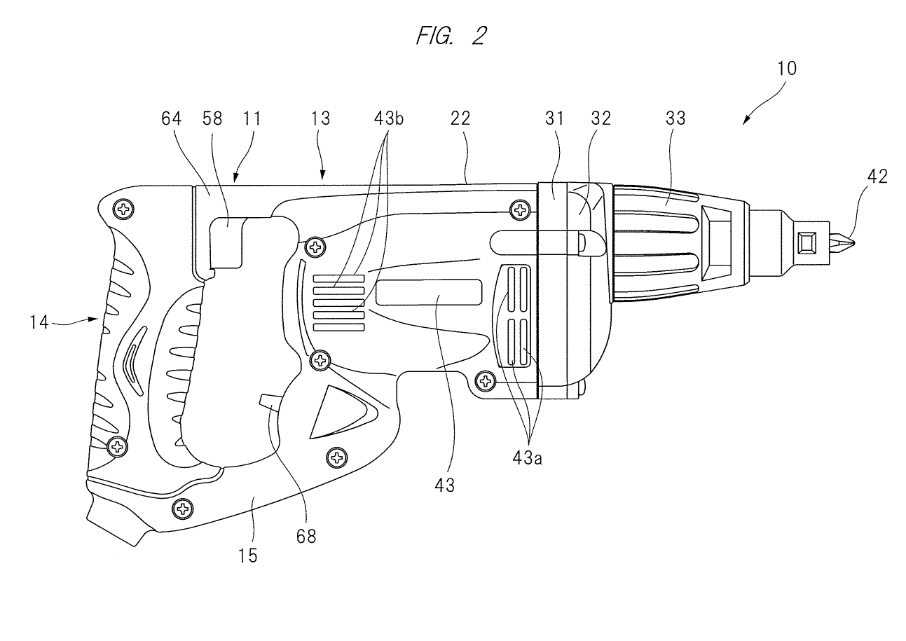

A driver serving as an example of an electrical power tool will be described with reference to FIGS. 1 to 5. This driver 10 includes a casing 11 serving as a device main body molded from a resin material, and the casing 11 configures an electrical power tool main body. The casing 11 includes: a motor housing 13 in which an electrical motor 12 is accommodated; a grip 14 connected to an end of the motor housing 13 through a second connecting unit 64; and a first connecting unit 15 that connects the grip 14 and the motor housing 13. The first connecting unit 15 and the second connecting unit 64 are connected to the motor housing 13 so as to be parallel to each other.

An accommodation chamber 16 for accommodating the electrical motor 12 and an accommodation chamber 18 for accommodating a power supply circuit unit 17 are provided in the motor housing 13, and a wall unit 19 that partitions the accommodation chamber 16 and the accommodation chamber 18 is provided. The accommodation chamber 16 and the accommodation chamber 18 are arranged so as to be next to each other in a length direction of the grip 14. The accommodation chamber 18 is arranged on an outer side of the electrical motor 12 in a radial direction centering a second axis line B.

A wall unit 21 that partitions the accommodation chamber 18 and an accommodation chamber 20 provided inside the grip 14 is provided inside the casing 11. The wall unit 21 connects an upper wall 22 of the motor housing 13 and a wall unit 23 provided at a position closest to the grip 14 in the motor housing 13. A vent hole 47 is provided between the wall unit 21 and the wall unit 19, and the vent hole 47 connects the accommodation chamber 16 and the accommodation chamber 18. The vent hole 47 is a passage that guides the air in the accommodation chamber 18 to the accommodation chamber 16. A cross-sectional shape of the upper wall 22 is an arc shape that swells outward from the motor housing 13. A vent hole 22a is provided in the upper wall 22, and the vent hole 22a connects outside of the casing 11 and the accommodation chamber 18.

Furthermore, the motor housing 13 includes two side walls 43 and a lower wall 24 provided so as to surround the accommodation chamber 16. Each of the two side walls 43 has an arc shape, and the lower wall 24 also has an arc shape. The side walls 43 are separately continued to both ends of the lower wall 24. The wall unit 19 continues upper ends of the two side walls 43. A vent hole 43a is provided at a side of a cooling fan 35 in each of the two side walls 43. The vent hole 43a connects the accommodation chamber 16 and outside of the casing 11. A wall unit 25 that connects the lower wall 24 and the wall unit 23 is also provided.

The electrical motor 12 is a brushless motor, and the electrical motor 12 includes: a stator 26 fixed to the motor housing 13; and a rotatable rotor 27. The stator 26 includes: an annular stator core 28; a plurality of teeth 28a provided on an inner side of the stator core 28; and a coil 29 wound around each of the plurality of teeth 28a. The rotor 27 includes a permanent magnet 27a, and the rotor 27 integrally rotates with an output shaft 30. A rotating direction of the output shaft 30 can be switched between forward rotation and reverse rotation.

A partition wall 31 is fixed to an end of the motor housing 13 on a side opposite to the wall unit 23. A gear cover 32 is attached to the partition wall 31, and a tubular cover 33 is attached to the gear cover 32. Two bearings 34 supported by the wall unit 23 and the partition wall 31 are provided, and the output shaft 30 is rotatably supported by the two bearings 34 so that a first axis line A is the center of rotation of the output shaft 30. The accommodation chamber 16 is formed between the wall unit 23 and the partition wall 31 in a direction along the first axis line A. The cooling fan 35 is provided between the electrical motor 12 and the partition wall 31 in the accommodation chamber 16. The cooling fan 35 is fixed to the output shaft 30, so that the cooling fan 35 rotates with the output shaft 30.

The partition wall 31 includes a shaft hole, so that the output shaft 30 is inserted to the shaft hole and a part of the output shaft 30 is positioned inside the gear cover 32. A drive gear 36 is provided on an outer circumferential surface of an area provided inside the gear cover 32 in the output shaft 30. Furthermore, a shaft 37 is provided inside the gear cover 32, which shaft 37 is rotatably supported by a bearing 38. The shaft 37 does not move in a direction along a second axis line B.

A driven gear 39 that integrally rotates with the shaft 37 is provided, and the driven gear 39 meshes with the drive gear 36. A number of teeth of the driven gear 39 is larger than a number of teeth of the drive gear 36, and therefore, when the torque of the output shaft 30 is transmitted to the shaft 37, a rotation speed of the shaft 37 becomes lower than a rotation speed of the output shaft 30. In other words, the drive gear 36 and the driven gear 39 configure a speed reducing mechanism.

A part of an arrangement region of the driven gear 39 and a part of an arrangement region of the power supply circuit unit 17 are overlapped with each other within a plane perpendicular to the first axis line A. In specific description, a part of the arrangement region of the driven gear 39 and a part of the arrangement region of the power supply circuit unit 17 are overlapped with each other in a radial direction and a circumferential direction centering the first axis line A. Furthermore, a part of the arrangement region of the driven gear 39 and a part of the arrangement region of the electrical motor 12 are overlapped with each other within a plane perpendicular to the first axis line A.

A spindle 40 is provided from inside of the gear cover 32 to inside of the cover 33. The spindle 40 includes a concave portion 40a centering the second axis line B, and one end of the shaft 37 is provided in the concave portion 40a. The spindle 40 and the shaft 37 are rotatable relatively to each other so as to center the second axis line B. The spindle 40 is movable in a direction along the second axis line B in the cover 33. The driven gear 39, the spindle 40, and the shaft 37 are concentrically provided. An outer diameter of the driven gear 39 is larger than an outer diameter of the spindle 40 or an outer diameter of the shaft 37.

A clutch mechanism 78 that connects or disconnects a power transmission path between the driven gear 39 and the spindle 40 is provided. The clutch mechanism 78 is provided in the gear cover 32, and the clutch mechanism 78 includes a movable member 79 provided between the driven gear 39 and the spindle 40. The movable member 79 is attached to the shaft 37, and the movable member 79 is movable in the direction along the second axis line B with respect to the shaft 37. The movable member 79 includes meshing portions 80, 81. The clutch mechanism 78 includes a meshing portion 82 provided on the spindle 40 and a meshing portion 83 provided on a side of the driven gear 39 opposite to the bearing 38. Furthermore, an elastic member 84 is provided between the driven gear 39 and the movable member 79. The elastic member 84 is a metallic compression spring.

The second axis line B and the first axis line A are parallel and are non-coaxial to each other. The first axis line A and the second axis line B are positionally shifted, that is, eccentric in a length direction of the grip 14. The distal end tool 42 serving as the work tool is held by the spindle 40. The distal end tool 42 shown in the drawings is a driver bit, and is used to tighten or loosen a screw member.

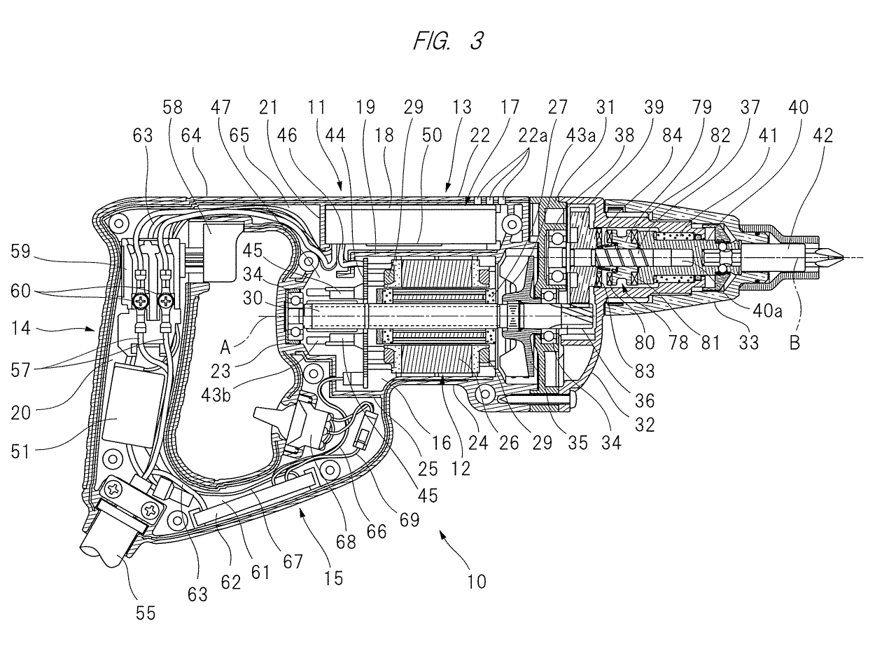

An element that supplies the power to the electrical motor 12 will be described with reference to FIGS. 3 to 5. First, an FET substrate 44 is provided in the accommodation chamber 16. The FET substrate 44 is fixed to the stator 26 so as not to rotate, and the output shaft 30 is provided in an axial hole provided in the FET substrate 44. A plurality of switching elements 45 are attached to the FET substrate 44. As the plurality of switching elements 45, for example, an FET (Field Effect Transistor) or others is used. The plurality of switching elements 45 are connected to a coil 29 for handling three phases, that is, a U phase, a V phase, and a Y phase.

In FIG. 3, a length direction of the switching element 45 is arranged on the FET substrate 44 so as to be substantially parallel to the output shaft 30. If the length direction of the switching element 45 is arranged in a direction orthogonal to the output shaft 30, note that a dimension in a direction of the output shaft 30 of the casing 11 can be also suppressed. The direction orthogonal to the output shaft 30 is a direction parallel to the FET substrate 44.

The FET substrate 44 is arranged between the electrical motor 12 and the wall unit 23 in the direction along the first axis line A. The plurality of switching elements 45 are arranged between the FET substrate 44 and the wall unit 23 in the direction along the first axis line A. An FET substrate unit 49 is formed of the FET substrate 44 and the plurality of switching elements 45. The FET substrate unit 49 plays a role of a so-called inverter circuit. The electrical motor 12, the FET substrate 44, and some of the switching elements 45 are arranged within an arrangement region of the electrical motor 12 in the direction along the first axis line A. Vent holes 43b of the two side walls 43 are provided on a lateral side of the plurality of switching elements 45. The vent hole 43b connects the outside of the casing 11 and the accommodation chamber 16.

The FET substrate 44 is connected to the power supply circuit unit 17 by a motor power supply cable 46. The motor power supply cable 46 is arranged over the accommodation chambers 16 and 18. The power supply circuit unit 17 includes a circuit substrate 48 and electrical components attached to the circuit substrate 48, such as a rectifying circuit 50, a film capacitor 51, and a normal mode filter 52. The film capacitor 51 has such a property as being difficult to generate heat. The normal mode filter 52 includes: a choke coil 52a for removing noise generated from an alternating-current power supply 56 supplied from a power supply cord 55; and a capacitor 52b for removing noise generated by the switching element 45. The alternating-current power supply 56 is, for example, a power supply having an alternating current of 100V. The rectifying circuit 50 is a diode bridge obtained by combining publicly-known four diodes 50a, and the rectifying circuit 50 is used to rectify the alternating-current power supply 56 to a direct current. A power supply circuit 54 is configured of the rectifying circuit 50, the film capacitor 51, the normal mode filter 52, and others. Furthermore, the power supply circuit unit 17 includes a cover 53 for covering the circuit substrate 48 and the electrical components.

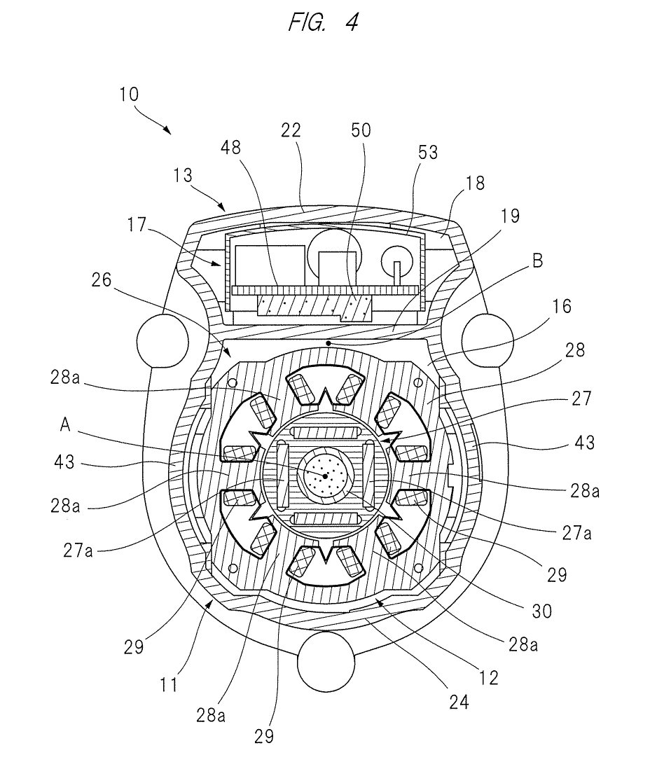

As shown in FIG. 4, the upper wall 22 of the casing 11 has a cross-sectional surface swelled as an arc shape. Thus, a space of the accommodation chamber 18 can be effectively utilized by arranging a tall electrical component at a central portion in the accommodation chamber 18 in a left and right direction of FIG. 4. The tall electrical component is an electrical component having a large protrusion amount from the surface of the circuit substrate 48. The increase in the dimension of the grip 14 of the casing 11 in the length direction can be suppressed. The length direction of the grip 14 is the direction along the second axis line B.

Powder dust entering the casing 11 from the vent hole 22a can be suppressed from directly colliding with the power supply circuit 54 by providing the cover 53, so that damages of the electrical components configuring the power supply circuit 54 can be suppressed. Note that the cover 53 may be provided only at the position opposed to the vent hole 22a, and the electrical components at other positions may be exposed from the cover 53. By configuring the cover 53 as described above, the powder dust can be suppressed from directly hitting the electrical components, and the electrical components can be efficiently cooled.

One end of the power supply cord 55 is connected to a connecting portion between the grip 14 and the first connecting unit 15 in the casing 11. A plug is provided at the other end of the power supply cord 55, and the plug is attachable to the alternating-current power supply 56. Two power supply cables 57 connected to the power supply cord 55 are provided, and the two power supply cables 57 are connected to the power supply circuit 54. The two power supply cables 57 are provided over the accommodation chamber 20 of the grip 14, the inside 65 of the second connecting unit 64, and the accommodation chamber 18.

A trigger 58 is provided at a portion close to the second connecting unit 64 in the grip 14. The trigger 58 is operated by an operator. A switch 59 is provided in the accommodation chamber 20 of the grip 14, and the switch 59 is connected or disconnected by the operation of the trigger 58. The two power supply cables 57 are fixed to an outer wall of the switch 59 by a screw 60. The film capacitor 51 is arranged between an end of the power supply cord 55 and the switch 59 in the accommodation chamber 20, and the film capacitor 51 is connected to the power supply circuit 54.

An accommodation chamber 61 is formed in the first connecting unit 15, and a control circuit 62 is provided in the accommodation chamber 61. The accommodation chamber 61 is arranged on an outer side of the electrical motor 12 in a radial direction centering the second axis line. The accommodation chamber 61 is arranged at a position opposite to the accommodation chamber 18 across the electrical motor 12.

The control circuit 62 is a known circuit that includes a controller 71, a control signal output circuit 72, and others. The control signal output circuit 72 outputs a pulse width modulation (PWM) signal, and controls a duty ratio which is a ratio between the ON and the plurality of switching elements 45. To the control circuit 62, an operation signal of the trigger 58, an operation signal of a forward/reverse rotation switch 68, a detection signal of an output shaft rotation number sensor 73, and others are input. The output shaft rotation number sensor 73 includes a plurality of hall elements arranged along the circumferential direction of the rotor 27, and others. A control circuit power supply cable 63 that connects the control circuit 62 and the power supply circuit 54 is provided. The control circuit power supply cable 63 is extended from the accommodation chamber 18 to the accommodation chamber 61 through the inside 65 and the accommodation chamber 20.

An FET drive signal cable 66 that connects the control circuit 62 and the FET substrate 44 is provided. The FET drive signal cable 66 is arranged in the accommodation chamber 61. Furthermore, a switch signal cable 67 that connects the control circuit 62 and the switch 59 is provided. The switch signal cable 67 is provided over the accommodation chamber 20 and the accommodation chamber 61.

The forward/reverse rotation switch 68 is provided in the accommodation chamber 61 of the first connecting unit 15. The forward/reverse rotation switch 68 is operated by the operator, and the forward/reverse rotation switch 68 is arranged between the control circuit 62 and the wall unit 25. A forward/reverse rotation switch signal cable 69 that connects the forward/reverse rotation switch 68 and the control circuit 62 is provided. The forward/reverse rotation switch signal cable 69 is arranged in the accommodation chamber 61.

In the driver 10, when the trigger 58 is operated, the power of the alternating-current power supply 56 is supplied to the electrical motor 12 through the power supply circuit 54, so that the output shaft 30 is rotated. The torque of the output shaft 30 is transmitted to the distal end tool 42 through the drive gear 36 and the driven gear 39. When the forward/reverse rotation switch 68 is operated, the output shaft 30 rotates forward or backward. The torque of the output shaft 30 is transmitted to the driven gear 39 through the drive gear 36.

Here, if the distal end tool 42 is not pressed against an object, the meshing portion 80 and the meshing portion 83 are separated from each other by the force of the elastic member 84. That is, the clutch mechanism 78 is released. Thus, the torque of the driven gear 39 is not transmitted to the spindle 40.

On the other hand, if the distal end tool 42 is pressed against the object, the meshing portion 80 and the meshing portion 83 are meshed with each other. That is, the clutch mechanism 78 is engaged. Thus, the torque of the driven gear 39 is transmitted to the distal end tool 42 through the spindle 40, and a work of tightening the screw member or loosening the screw member is performed.

The length direction of the grip 14 shown in FIG. 3 corresponds to the up and down direction of FIG. 4. That is, when a lateral surface of the motor housing 13 is viewed as a cross-sectional view, the second axis line B is arranged between the accommodation chamber 18 and the first axis line A in the length direction of the grip 14. The first axis line A and the second axis line B are arranged at different positions from each other in the length direction of the grip 14, and a distance from the upper wall 22 to the first axis line A is longer than a distance from the upper wall 22 to the second axis line B. The electrical motor 12 is arranged at a different position from the drive gear 36 and the driven gear 39 which serve as the speed reducing mechanism in the direction along the first axis line A. An empty space between the upper wall 22 of the motor housing 13 and the electrical motor 12 is the accommodation chamber 18, and the power supply circuit unit 17 is arranged in the accommodation chamber 18. Thus, the increase in the size of the driver 10 in the radial direction of the electrical motor 12 can be suppressed. In other words, the increase in the size of the driver 10 in the length direction of the grip 14 or the direction intersecting the first axis line A can be suppressed, so that the workability and the operability can be improved.

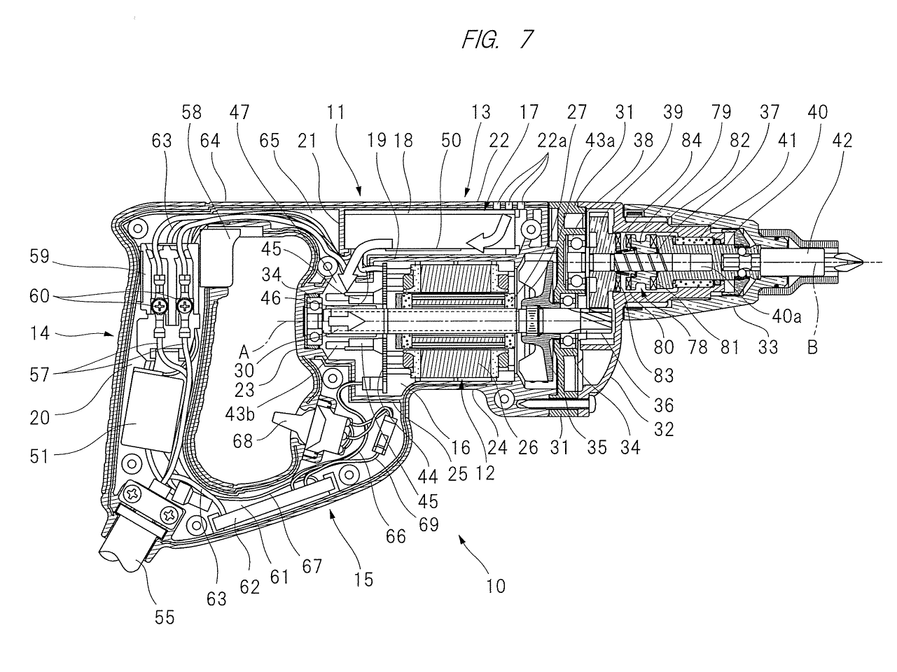

Incidentally, the electrical motor 12 generates heat when power is supplied to the coil 29, the power supply circuit unit 17 generates heat when power is supplied to the diode 50a, and the FET substrate unit 49 generates heat when power is supplied to the switching element 45. The driver 10 of the present embodiment can cool the electrical motor 12, the power supply circuit unit 17, and the FET substrate 49 as follows. When the output shaft 30 rotates, the cooling fan 35 rotates, so that the air outside the casing 11 enters the accommodation chamber 18 through the vent hole 22a as shown in FIG. 7, and thus, the power supply circuit unit 17 is cooled. The air that has entered the accommodation chamber 18 enters the accommodation chamber 16 through the vent hole 47. Furthermore, the air outside the casing 11 enters the accommodation chamber 16 through the vent hole 43b. Therefore, the FET substrate unit 49 and the electrical motor 12 are cooled, and the air of the accommodation chamber 16 is discharged from the vent hole 43a to the outside of the casing 11.

In other words, fresh air from the outside of the casing 11 is taken in, and the power supply circuit unit 17 and the FET substrate unit 49 are cooled by the air first. The fresh air means air having a temperature lower than the temperature of the component provided in the casing 11. Then, the air cools the electrical motor 12, and is discharged to the outside of the casing 11. Since the electrical motor 12 is cooled by the air obtained after cooling the power supply circuit unit 17 and the FET substrate unit 49, the temperature of the air that cools the electrical motor 12 is higher than the temperature of the air before cooling the power supply circuit unit 17 and others. However, the air that has entered from the two vent holes 22a and 43b merge with the air having the high temperature and cools the electrical motor 12, and therefore, the air volume increases, so that the electrical motor 12 can be effectively cooled.

In the driver 10, various types of cables are arranged so as not to block the flow of air in the casing 11. While a part of two power supply cables 57, a part of the motor power supply cable 46, a part of the cable of the film capacitor 51, and a part of the control circuit power supply cable 63 are arranged in the vent hole 47 which is the path through which the air passes and the accommodation chambers 16 and 18, the FET drive signal cable 66, the switch signal cable 67, and the forward/reverse rotation switch signal cable 69 are not arranged in the vent hole 47 and the accommodation chambers 16 and 18. Therefore, the block of the flow of air can be suppressed.

Furthermore, the vent hole 47 is provided in the wall unit 19 that partitions the accommodation chamber 16 for accommodating the electrical motor 12 and the accommodation chamber 18 for accommodating the power supply circuit unit 17. On the other hand, a vent hole is not provided in the wall unit 25 that partitions the accommodation chamber 16 and the accommodation chamber 61 for accommodating the control circuit 62. Therefore, the air that has entered the accommodation chamber 18 from the vent hole 22a can efficiently flow toward the electrical motor 12 side. Besides, even if rain water or others enters, flowing of the rain water or others toward the control circuit 62 side can be suppressed. In other words, the power supply circuit unit 17 and the electrical motor 12 can be efficiently cooled by providing the vent hole 47 connecting the accommodation chamber 16 and the accommodation chamber 18 and providing the vent hole 22a in the upper wall 22 of the motor housing 13 forming the accommodation chamber 18. On the other hand, the entering of the rain water or others into the accommodation chamber 61 at which the control circuit 62 is positioned can also be suppressed.

Furthermore, the switching element 45 for controlling the power supply to the electrical motor 12 is arranged in the accommodation chamber 16. Since the accommodation chamber 16 is a passage for the cooling air, the switching element 45 can also be efficiently cooled. The vent hole 22a and a vent hole 75 are arranged so as to be shifted in the direction of extension of the power supply circuit unit 17. The direction of the extension of the power supply circuit unit 17 is the direction along the second axis line B. Thus, the distance of the flow of the cooling air along the power supply circuit unit 17 can be increased, so that the power supply circuit unit 17 can be efficiently cooled.

### Second Embodiment

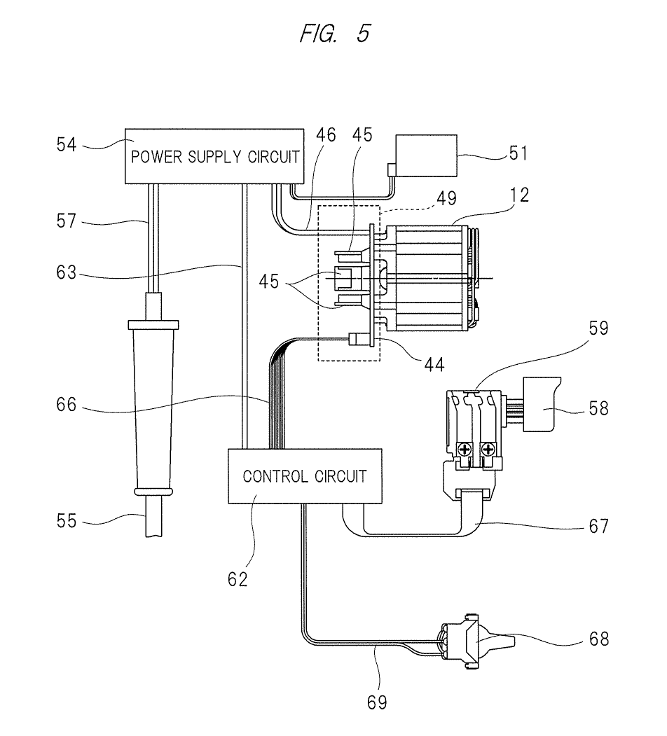

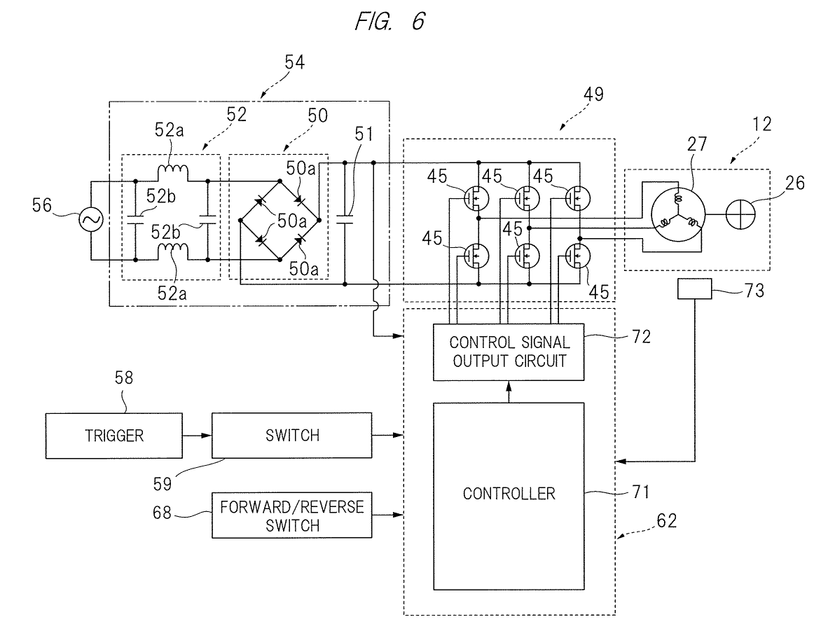

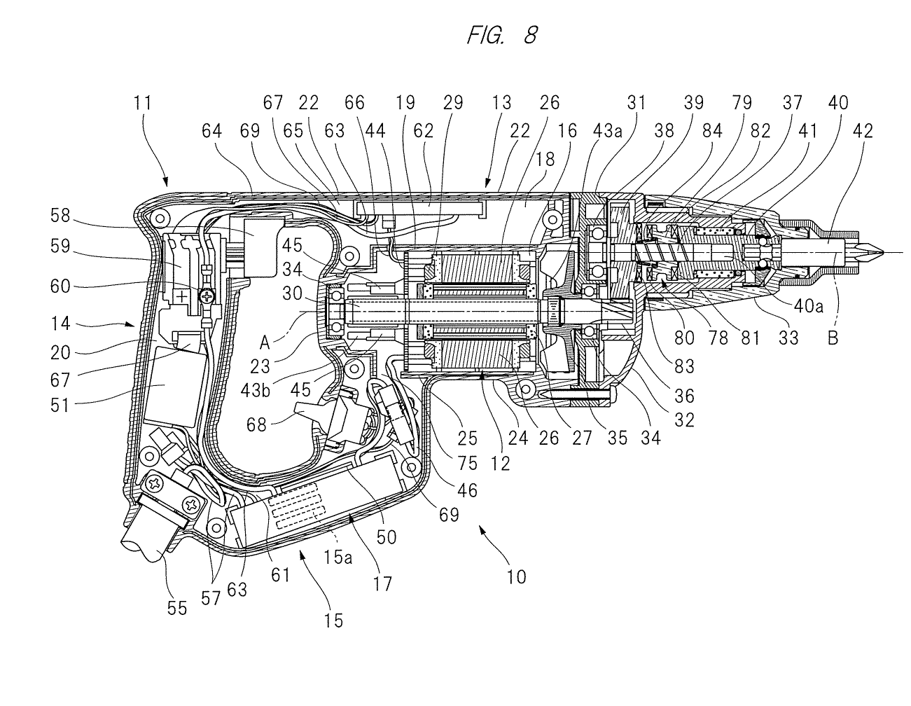

A driver of a second embodiment will be described with reference to FIGS. 5, 6 and 8 to 10. In a driver 10 of the second embodiment, the portions having the same configuration as that of the driver 10 of the first embodiment are denoted with the same reference symbols as those of the driver 10 of the first embodiment. The connection relation among the electrical elements shown in FIG. 5 and the control system shown in FIG. 6 are also applied to the driver 10 of the second embodiment.

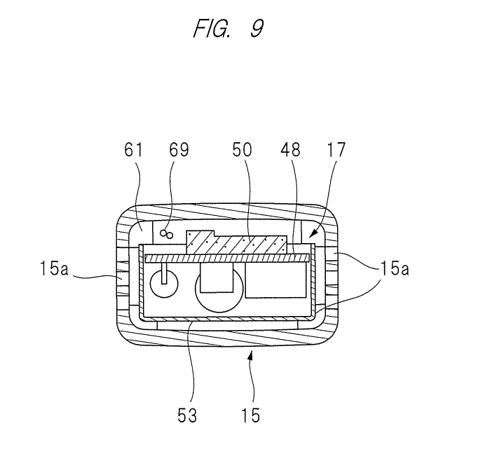

In the driver 10 of the second embodiment, the control circuit 62 is provided in the accommodation chamber 18, and the power supply circuit unit 17 is accommodated in the accommodation chamber 61 of the first connecting unit 15. As shown in FIG. 9, the vent hole 15a is provided on both sides of the accommodation chamber 61 in the first connecting unit 15. The vent hole 15a connects the accommodation chamber 61 and the outside of the casing 11. The driver 10 according to the second embodiment is not provided with the vent hole 47 but provided with the vent hole 75 in the wall unit 25. Furthermore, the wall unit 21 is not provided between the inside 65 and the accommodation chamber 18. Further, the vent hole 22a is not provided in the upper wall 22 of the motor housing 13.

The vent hole 75 connects the accommodation chamber 16 and the accommodation chamber 61 of the first connecting unit 15. The motor power supply cable 46 is arranged over the accommodation chamber 61, the vent hole 75, and the accommodation chamber 18. The two power supply cables 57 are provided in the accommodation chamber 61. Furthermore, the control circuit power supply cable 63 is arranged over the accommodation chambers 61 and 20, the inside 65, and the accommodation chamber 18.

Meanwhile, the FET drive signal cable 66 is arranged over the accommodation chambers 16, 18. The forward/reverse rotation switch signal cable 69 is arranged over the accommodation chamber 18, the inside 65, and the accommodation chambers 20, 61. The switch signal cable 67 is arranged over the accommodation chamber 18, the inside 65, and the accommodation chamber 20.

In the driver 10 of the second embodiment, a part of the arrangement region of the control circuit 62 and a part of the arrangement region of the driven gear 39 are overlapped with each other within a plane perpendicular to the first axis line A. Specifically, a part of the arrangement region of the control circuit 62 and a part of the arrangement region of the driven gear 39 are overlapped with each other in the radial direction and the circumferential direction centering the first axis line A. Furthermore, a part of the arrangement region of the driven gear 39 and a part of the arrangement region of the electrical motor 12 are overlapped with each other within a plane perpendicular to the first axis line A. Moreover, a part of the arrangement region of the electrical motor 12 and a part of the arrangement region of the switching element 45 are arranged within the arrangement region of the control circuit 62 in the direction along the first axis line A. The FET substrate 44 is arranged in the arrangement region of the control circuit 62 in the direction along the first axis line A.

As similar to the driver 10 of the first embodiment, the driver 10 of the second embodiment can supply the power of the alternating-current power supply 56 to the electrical motor 12 to rotate the distal end tool 42, so that the work of tightening the screw member or the work of loosening the screw member can be performed. In the driver of the second embodiment, an empty space between the upper wall 22 of the motor housing 13 and the electrical motor 12 is used as the accommodation chamber 18, and the control circuit 62 is arranged in the accommodation chamber 18. Thus, the increase in the size of the driver 10 in the radial direction of the electrical motor 12 can be suppressed. Therefore, the increase in the size of the driver 10 in the length direction of the grip 14 can be suppressed, so that the workability and the operability can be improved.

On the other hand, in the driver 10 of the second embodiment, when the output shaft 30 is rotated and the cooling fan 35 is rotated, the air outside the casing 11 enters the accommodation chamber 61 from the vent hole 15a, and the air that has entered the accommodation chamber 61 enters the accommodation chamber 16 through the vent hole 75. The air outside the casing 11 enters the accommodation chamber 16 through the vent hole 43b. The air that has entered the accommodation chamber 16 is discharged to the outside of the casing 11 from the vent hole 43a. Therefore, the driver 10 of the second embodiment can cool the power supply circuit unit 17 and cool the FET substrate unit 49, and can also cool the electrical motor 12.

The two power supply cables 57, the control circuit power supply cable 63, and the switch signal cable 67 are not arranged on a path through which the air passes in the casing 11. Therefore, in the driver 10, the block of the flow of air in the casing 11 can be suppressed. As similar to the driver 10 of the first embodiment, the power supply circuit unit 17 and the electrical motor 12 can be efficiently cooled, and the entering of water or others toward the control circuit 62 side can be suppressed.

### Third Embodiment

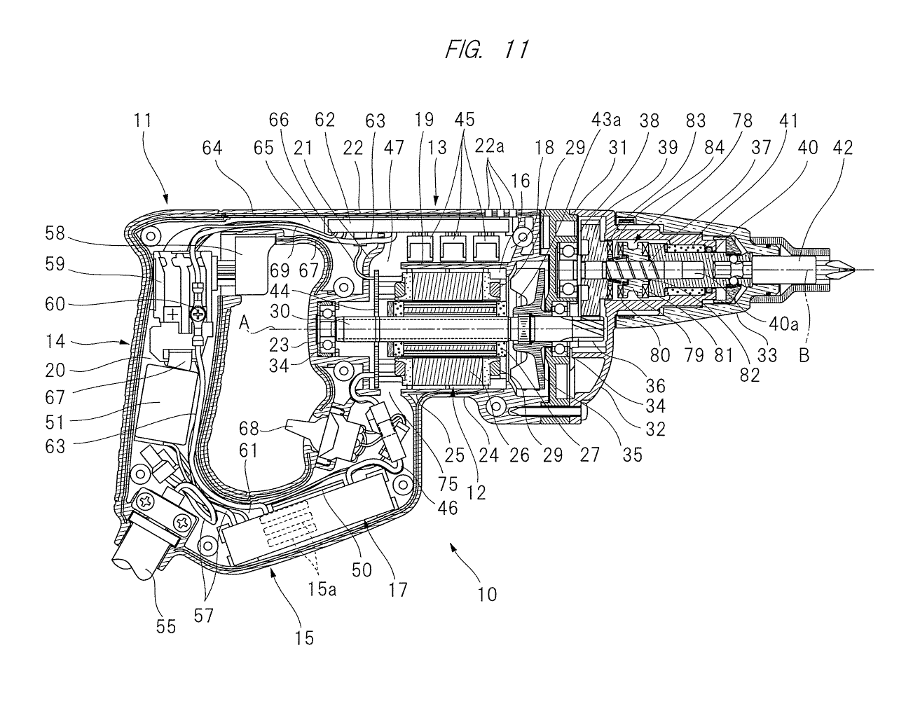

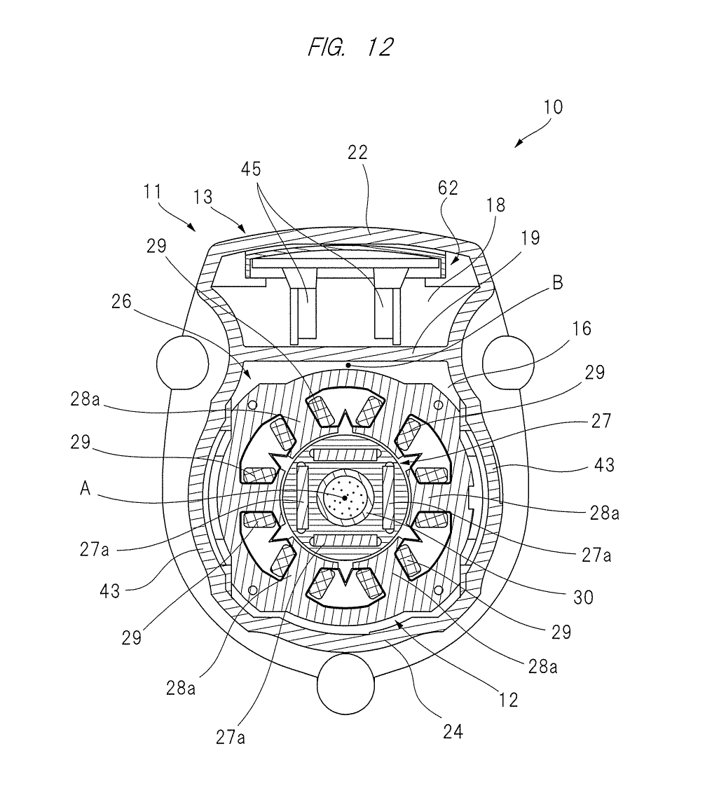

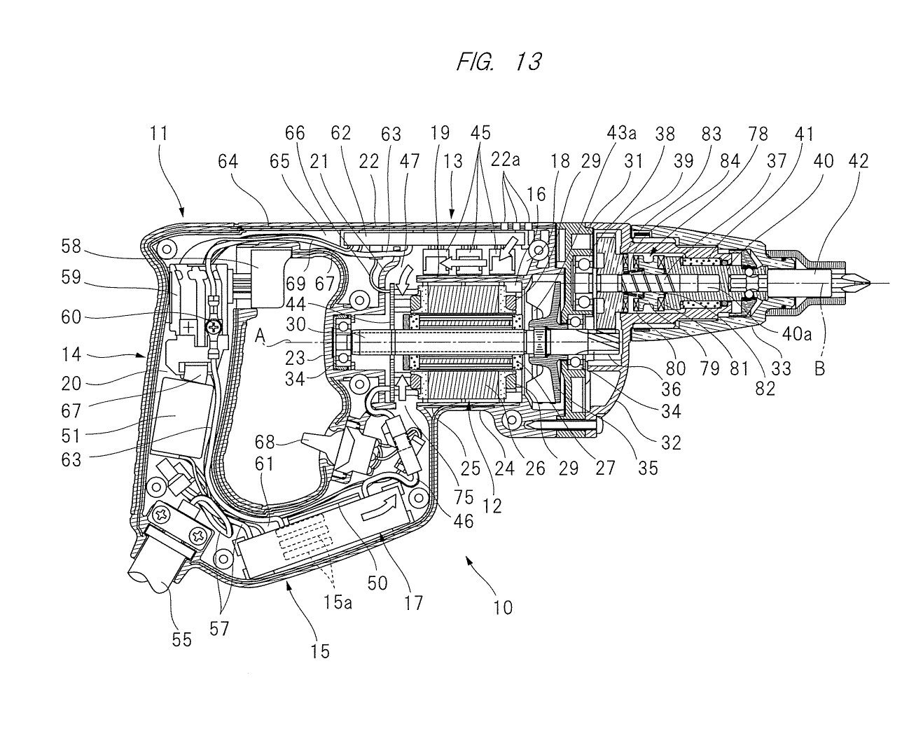

A driver of a third embodiment will be described with reference to FIGS. 5, 6, and 11 to 13. A driver 10 of the third embodiment has substantially the same configuration as that of the driver 10 of the second embodiment. Thus, in the driver 10 of the third embodiment, the portions having the same configuration as that of the driver 10 of the second embodiment are denoted with the same reference symbols as those of the driver 10 of the second embodiment. The connection relation among the electrical elements shown in FIG. 5 and the control system shown in FIG. 6 are also substantially applied to the driver 10 of the third embodiment.

However, in FIG. 5, the configuration in which the switching element 45 is attached to the FET substrate 44 is not applied to the driver 10 of the third embodiment. In the driver 10 of the third embodiment, the switching element 45 is attached to the control circuit 62. In other words, the switching element 45 is not attached to the FET substrate 44, but the switching element 45 is provided in the accommodation chamber 18. The switching element 45 is attached to the control circuit 62, and the switching element 45 is arranged between the electrical motor 12 and the control circuit 62. The plurality of switching elements 45 are arranged so as to be next to each other in the direction along the second axis line B. That is, the plurality of switching elements 45 are next to each other in the direction orthogonal to the planar direction of the FET substrate 44.

The driver 10 of the third embodiment includes the vent hole 47 described in the driver 10 of the first embodiment. Furthermore, the driver 10 of the third embodiment includes the wall unit 21 described in the driver 10 of the first embodiment. A gap is formed between the wall unit 21 and the upper wall 22, where the control circuit 62 is arranged over the inside 65 and the accommodation chamber 18. Furthermore, the driver 10 of the third embodiment includes the vent hole 22a in the upper wall 22. Moreover, the vent hole 43b is not provided in the motor housing 13 in the driver 10 of the third embodiment.

In the driver 10 of the third embodiment, a part of the arrangement region of the control circuit 62 and a part of the arrangement region of the driven gear 39 are overlapped with each other within a plane perpendicular to the first axis line A. Specifically, a part of the arrangement region of the control circuit 62, a part of the arrangement region of the switching element 45, and a part of the arrangement region of the driven gear 39 are overlapped with each other in the radial direction and the circumferential direction centering the first axis line A. A part of the arrangement region of the driven gear 39 and a part of the arrangement region of the electrical motor 12 are overlapped with each other within a plane perpendicular to the first axis line A. Moreover, the electrical motor 12, the switching element 45, and the FET substrate 44 are arranged within the arrangement region of the control circuit 62 in the direction along the first axis line A. The vent holes 47, 75 are both provided in the third embodiment.

In the driver 10 of the third embodiment, the same operation is performed at the same configuring portions as those of the driver 10 of the second embodiment, and therefore, the same effects are obtained. Also in the driver 10 of the third embodiment, the accommodation chamber 18 is provided by using the space formed between the electrical motor 12 and the upper wall 22, and the control circuit 62 and the switching element 45 are arranged in the accommodation chamber 18, and therefore, the increase in the size of the driver 10 in the radial direction of the electrical motor 12, that is, in the length direction of the grip 14 can be suppressed. The switching element 45 is not provided between the FET substrate 44 and the wall unit 23, and thus the space between the FET substrate 44 and the wall unit 23 can be formed as narrow as possible. Therefore, in the driver 10, the entire length in the direction along the first axis line A can be formed as short as possible.

Furthermore, in the driver 10 of the third embodiment, when the cooling fan 35 is rotated, the air outside the casing 11 enters the accommodation chamber 61 through the vent hole 15a. The air that has entered the accommodation chamber 61 reaches the accommodation chamber 16 through the vent hole 75. On the other hand, the air outside the casing 11 enters the accommodation chamber 18 through the vent hole 22a. The air that has entered the accommodation chamber 18 enters the accommodation chamber 16 through the vent hole 47. The air that has entered the accommodation chamber 16 is discharged to the outside of the casing 11 through the vent hole 43a. Therefore, the power supply circuit unit 17, the control circuit 62, the switching element 45, the electrical motor 12, and others can be cooled. Furthermore, even if water or others enters the casing 11 from the vent hole 22a, the water or others can be discharged from the vent hole 15a through the vent holes 47, 75, and therefore, the water or others can be suppressed from retaining in the casing 11.

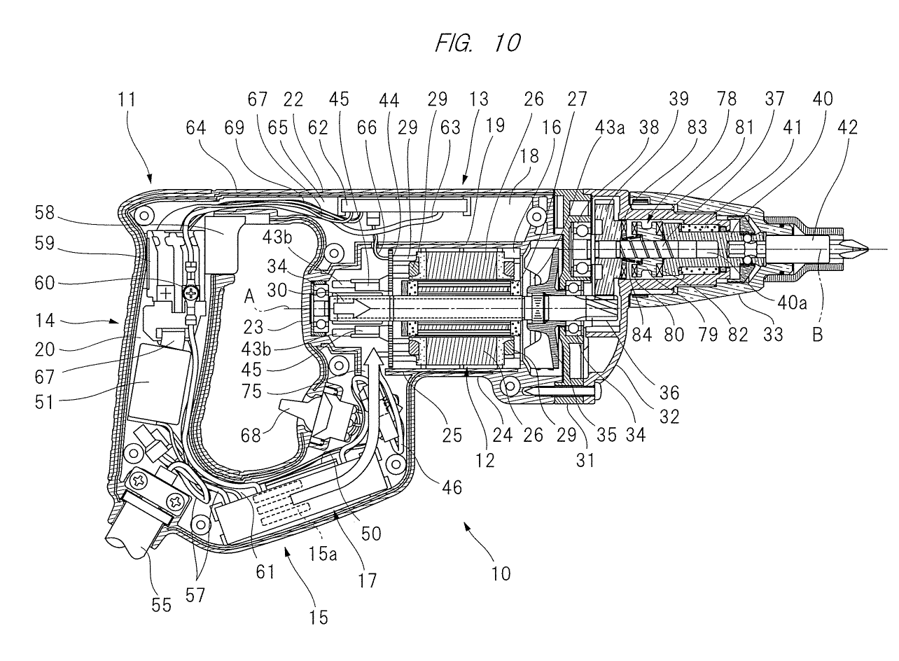

Note that FIG. 11 shows an example of arrangement of the plurality of switching elements 45 in the direction orthogonal to the planar direction of the FET substrate 44. On the other hand, the plurality of switching elements 45 can be arranged to be parallel to the planar direction of the FET substrate 44. Alternatively, as the plurality of switching elements 45, a switching element 45 of a type to be mounted along the planar direction of the FET substrate 44 can be also used. By arranging the plurality of switching elements 45 as described above, the dimension of the accommodation chamber 18 in the up and down direction can be further suppressed in FIG. 11.

The switching element 45 may be arranged between the control circuit 62 and the upper wall 22. According to such a configuration, the switching element 45 is arranged so as to face the vent hole 22a, and therefore, the switching element 45 can be cooled with air having a lower temperature.

### Fourth Embodiment

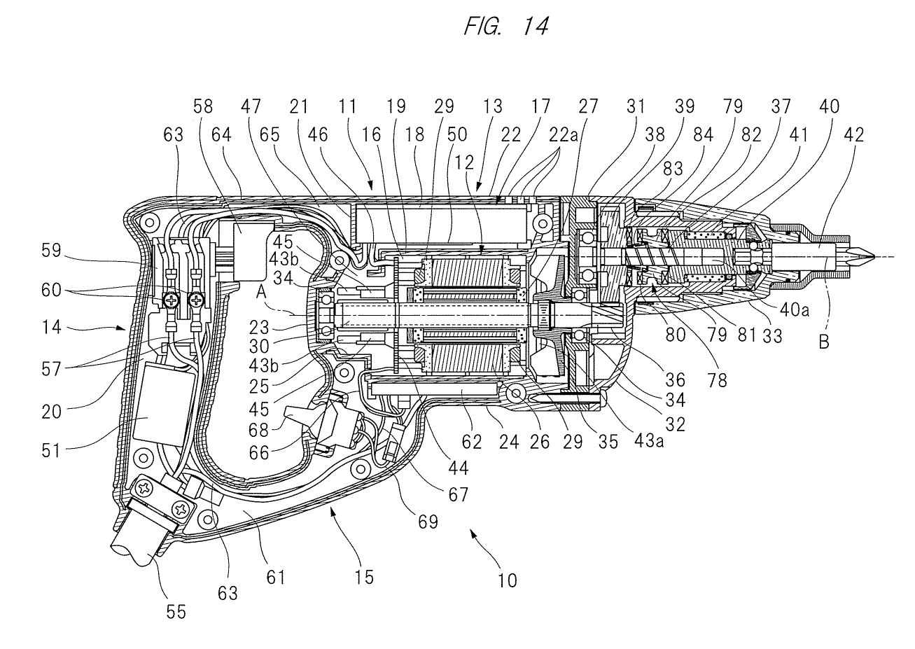

A driver of a fourth embodiment will be described with reference to FIGS. 5, 6, 14, and 15. A driver 10 of the fourth embodiment has substantially the same configuration as that of the driver 10 of the first embodiment. Thus, in the driver 10 of the fourth embodiment, the portions having the same configuration as that of the driver 10 of the first embodiment are denoted with the same reference symbols as those of the driver 10 of the first embodiment. The connection relation among the electrical elements shown in FIG. 5 and the control system shown in FIG. 6 are also applied to the driver 10 of the fourth embodiment.

In the driver 10 of the fourth embodiment, a part of the wall unit 25 is arranged between the lower wall 24 and the wall unit 19, and the accommodation chamber 16 is formed between the wall unit 25 and the wall unit 19. Furthermore, a gap is formed between the wall unit 25 and the lower wall 24, and a part of the accommodation chamber 61 is formed between the wall unit 25 and the lower wall 24. A part of the control circuit 62 provided in the accommodation chamber 61 is arranged between the wall unit 25 and the lower wall 24.

In the driver 10 of the fourth embodiment, a part of the arrangement region of the power supply circuit unit 17 and a part of the arrangement region of the driven gear 39 are overlapped with each other within a plane perpendicular to the first axis line A. Specifically, a part of the arrangement region of the power supply circuit unit 17 and a part of the arrangement region of the driven gear 39 are overlapped with each other in the radial direction and the circumferential direction centering the first axis line A.

A part of the arrangement region of the driven gear 39 and a part of the arrangement region of the electrical motor 12 are overlapped with each other within the plane perpendicular to the first axis line A. Furthermore, the electrical motor 12, some of the switching element 45, the FET substrate 44 and the control circuit 62 are arranged within the arrangement region of the power supply circuit unit 17 in the direction along the first axis line A. In other words, the control circuit 62 and the power supply circuit unit 17 are arranged at opposite positions to each other across the first axis line A.

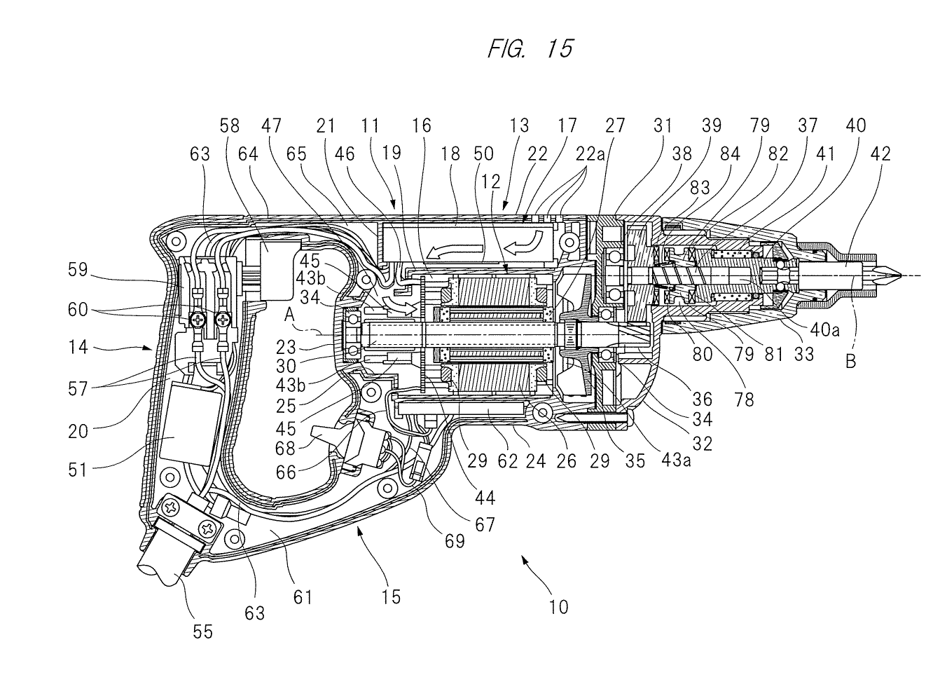

In the driver 10 of the fourth embodiment, the same operation is performed in the same configuring portions as those of the driver 10 of the first embodiment, and therefore, the same effects are obtained. Also in the driver 10 of the fourth embodiment, the accommodation chamber 18 is provided by using the space formed between the electrical motor 12 and the upper wall 22, and the power supply circuit unit 17 is arranged in the accommodation chamber 18. Therefore, the increase in the size of the driver 10 in the radial direction of the electrical motor 12, that is, in the length direction of the grip 14 can be suppressed. A part of the control circuit 62 provided in the accommodation chamber 61 is arranged between the wall unit 25 and the lower wall 24. Therefore, the increase in the size of the driver 10 in the length direction of the grip 14 can be further suppressed. In the driver 10 of the fourth embodiment, note that the flow path of the air that enters the casing 11 is the same as that of the driver 10 of the first embodiment as shown with an arrow in FIG. 15.

### Fifth Embodiment

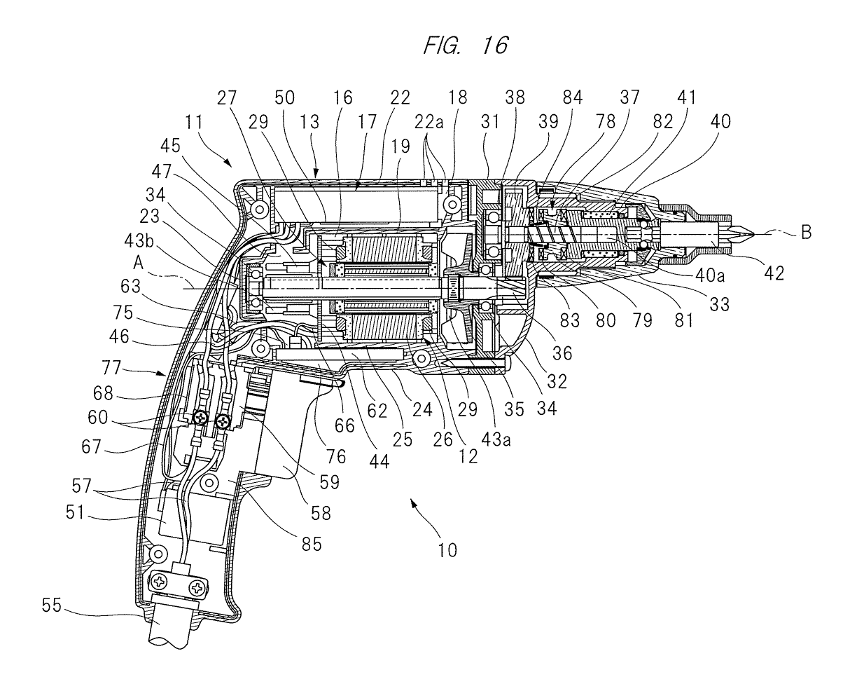

A driver of a fifth embodiment will be described with reference to FIGS. 5, 6 and 16. In a driver 10 of the fifth embodiment, the portions having the same configuration as that of the driver 10 of the first embodiment are denoted with the same reference symbols as those of the driver 10 of the first embodiment. The connection relation among the electrical elements shown in FIG. 5 and the control system shown in FIG. 6 are also applied to the driver 10 of the fifth embodiment.

In the driver 10 of the fifth embodiment, a part of the wall unit 25 is arranged between the lower wall 24 and the wall unit 19, and an accommodation chamber 76 is formed between the wall unit 25 and the lower wall 24. That is, the accommodation chamber 76 is arranged in the motor housing 13, and the control circuit 62 is accommodated in the accommodation chamber 76. The accommodation chamber 76 is arranged on the outer side of the electrical motor 12 in the radial direction centering the second axis line B. The accommodation chamber 76 is arranged at a position opposite to the accommodation chamber 18 across the electrical motor 12. In the fifth embodiment, the vent holes 47, 75 are both provided.

Meanwhile, a grip 77 is provided at an end on a side opposite to the partition wall 31 in the motor housing 13. In the front view of the driver 10, the casing 11 is formed into an “L” shape formed of the motor housing 13 and the grip 77. An accommodation chamber 85 is formed in the grip 77, and the accommodation chamber 85 and the inside of the motor housing 13 are partitioned from each other by the wall unit 23. The vent hole 75 is provided between the wall unit 25 and the wall unit 23, and the vent hole 75 connects the accommodation chamber 16 and the accommodation chamber 76. The power supply cord 55 is attached to the end of the grip 77, and the film capacitor 51, the switch 59, the forward/reverse rotation switch 68, and others are accommodated in the accommodation chamber 85.

The trigger 58 is attached to the grip 77. The two power supply cables 57 that connect the power supply cord 55 and the power supply circuit unit 17 are arranged in the accommodation chamber 85. The switch signal cable 67 that connects the control circuit 62 and the switch 59 is provided in the accommodation chamber 85. The motor power supply cable 46 that connects the FET substrate 44 and the power supply circuit unit 17 is arranged over the accommodation chambers 18, 85. Furthermore, the control circuit power supply cable 63 that connects the control circuit 62 and the power supply circuit unit 17 is extended from the accommodation chamber 18 to the accommodation chambers 16, 76 through the accommodation chamber 85.

The grip 77 is extended from the motor housing 13 in the radial direction of a circle centering the first axis line A so as to be directed away from the first axis line A. The trigger 58, the switch 59, and the film capacitor 51 are arranged between the power supply cord 55 and the control circuit 62 in the radial direction of the circle centering the first axis line A.

Also in the driver 10 of the fifth embodiment, the accommodation chamber 18 is provided in an empty space formed between the electrical motor 12 and the upper wall 22, and the power supply circuit unit 17 is accommodated in the accommodation chamber 18. A part of the arrangement region of the electrical motor 12 and a part of the arrangement region of the driven gear 39 are overlapped with each other within a plane perpendicular to the first axis line A. A part of the arrangement region of the power supply circuit unit 17 and a part of the arrangement region of the driven gear 39 are overlapped with each other within a plane perpendicular to the first axis line A. Specifically, a part of the arrangement region of the power supply circuit unit 17 and a part of the arrangement region of the driven gear 39 are overlapped with each other in the radial direction and the circumferential direction centering the first axis line A. Moreover, the control circuit 62, the electrical motor 12, the FET substrate 44, and the switching element 45 are arranged in the arrangement region of the power supply circuit unit 17 in the direction along the first axis line A. The power supply circuit unit 17 and the control circuit 62 are arranged at opposite positions to each other across the first axis line A.

In the driver 10 of the fifth embodiment, the same operation is performed in the same configuring portions as those of the driver 10 of the first embodiment, and therefore, the same effects are obtained. Also in the driver 10 of the fifth embodiment, the accommodation chamber 18 is provided by using the space formed between the electrical motor 12 and the upper wall 22, and the power supply circuit unit 17 is arranged in the accommodation chamber 18. Therefore, the increase in the size of the driver 10 in the radial direction of the electrical motor 12, that is, in the length direction of the grip 14 can be suppressed. The control circuit 62 is arranged between the wall unit 25 and the lower wall 24. Therefore, the increase in the size of the driver 10 in the length direction of the grip 14 can be further suppressed.

In the driver 10 of the fifth embodiment, when the cooling fan 35 is rotated, the air outside the casing 11 enters the accommodation chamber 18 through the vent hole 22a. The air that has entered the accommodation chamber 18 enters the accommodation chamber 16 through the vent hole 47. Also, the air outside the casing 11 enters the accommodation chamber 16 through the vent hole 43b. As described above, the air that has entered the accommodation chamber 16 is discharged to the outside of the casing 11 through the vent hole 43a. Therefore, in the driver 10 of the fifth embodiment, the heat is removed from the power supply circuit unit 17, the switching element 45, the electrical motor 12, and others in the course of the flow of the air in the casing 11, so that the power supply circuit unit 17, the switching element 45, the electrical motor 12, and others can be cooled.

In the explanation for the correspondence relation between the configuration described in each of the embodiments and the configuration of the present invention, the power transmitting mechanism of the present invention includes the driven gear 39 and the spindle 40, the electrical component of the present invention includes the electrical motor 12, the power supply circuit unit 17, the control circuit 62, the FET substrate 44, the switching element 45, the circuit substrate 48, and others, and the first axis line A corresponds to an axis line of the present invention.

In the explanation for the relation between the configurations described in the first sand fourth embodiments and the configuration of the present invention, the accommodation chamber 16 corresponds to a second accommodation chamber and a motor accommodation space of the present invention, the accommodation chamber 18 corresponds to a first accommodation chamber, a first accommodation space, and a substrate accommodation space of the present invention, the wall unit 19 corresponds to a first wall unit of the present invention, the wall unit 25 corresponds to a second wall unit of the present invention, the vent hole 22a corresponds to a vent hole and a first vent hole of the present invention, the FET substrate 44 corresponds to a substrate of the present invention, the circuit substrate 48 corresponds to a circuit substrate of the present invention, the vent hole 47 corresponds to a first connection hole and a second vent hole of the present invention, and the accommodation chamber 61 corresponds to a second accommodation space of the present invention.

In the explanation for the relation between the configuration described in the second embodiment and the configuration of the present invention, the accommodation chamber 16 corresponds to a second accommodation chamber and a motor accommodation space of the present invention, the accommodation chamber 18 corresponds to a second accommodation space of the present invention, the wall unit 25 corresponds to a first wall unit of the present invention, the wall unit 19 corresponds to a second wall unit of the present invention, the vent hole 15a corresponds to a vent hole and a first vent hole of the present invention, the vent hole 75 corresponds to a first connection hole and a second vent hole of the present invention, the FET substrate 44 corresponds to an electrical component of the present invention, the circuit substrate 48 corresponds to a circuit substrate of the of the present invention, and the accommodation chamber 61 corresponds to a first accommodation chamber, a first accommodation space, and a substrate accommodation space of the present invention.

In the explanation for the relation between the configuration described in the third embodiment and the configuration of the present invention, the vent hole 47 corresponds to a second connection hole of the present invention. The relation between other configurations described in the third embodiment and the configuration of the present invention is the same as the relation between the configuration of the second embodiment and the configuration of the present invention.

In the explanation for the relation between the configuration described in the fifth embodiment and the configuration of the present invention, the accommodation chamber 18 corresponds to a first accommodation chamber, a first accommodation space, and a substrate accommodation space of the present invention, the accommodation chamber 76 corresponds to a second accommodation space of the present invention, the wall unit 19 corresponds to a first wall unit of the present invention; the wall unit 25 corresponds to a second wall unit of the present invention, the vent hole 22a corresponds to a vent hole and a first vent hole of the present invention, the FET substrate 44 corresponds to a substrate of the present invention, the circuit substrate 48 corresponds to a circuit substrate of the present invention, the vent hole 47 corresponds to a first connection hole and a second vent hole of the present invention, and the vent hole 75 corresponds to a second connection hole of the present invention.

The present invention is not limited to the foregoing embodiments and various modifications can be made within the scope of the present invention. For example, the electrical motor 12 is not limited to the three phase brushless motor, and may be a reluctance motor in which the permanent magnet is not provided on the rotor, and various types can be used. The electrical power tool of the present invention includes not only the driver but also a drill for opening a hole in an object by rotating the distal end tool, and a hammer driver and a hammer drill that applies a rotation force and a striking force in the direction along the second axis line onto the distal end tool. In other words, the distal end tool includes not only a drill bit but also a driver bit. The work tool of the present invention includes not only the distal end tool for processing the object but also an adapter, an extension bar, and others for connecting the spindle and the distal end tool.

The electrical power tool of the present invention merely needs to have the arrangement region of the electrical motor and the arrangement region of the power supply circuit at least partially overlapped with each other in the direction along the first axis line. Further, the electrical power tool of the present invention merely needs to have the arrangement region of the electrical motor and the arrangement region of the control circuit at least partially overlapped with each other in the direction along the first axis line. Moreover, the electrical power tool of the present invention merely needs to have the arrangement region of the electrical component and the arrangement region of the power transmitting mechanism at least partially overlapped with each other in the circumferential direction centering the output shaft of the electrical motor.

### Sixth Embodiment

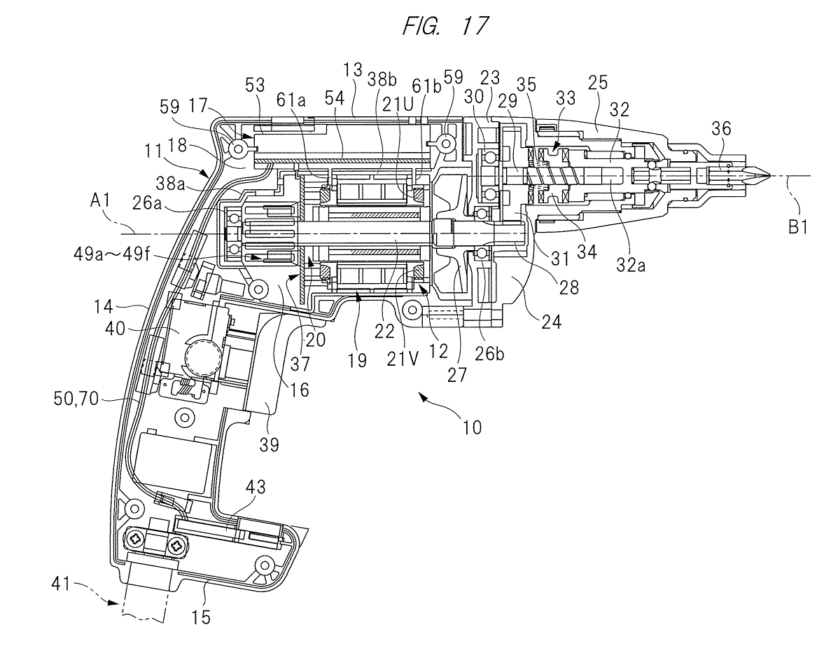

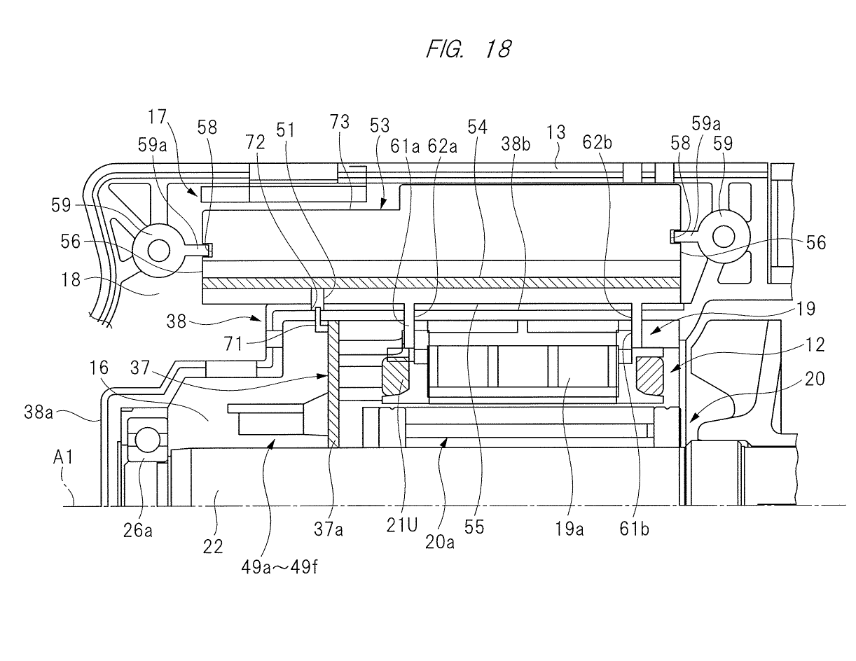

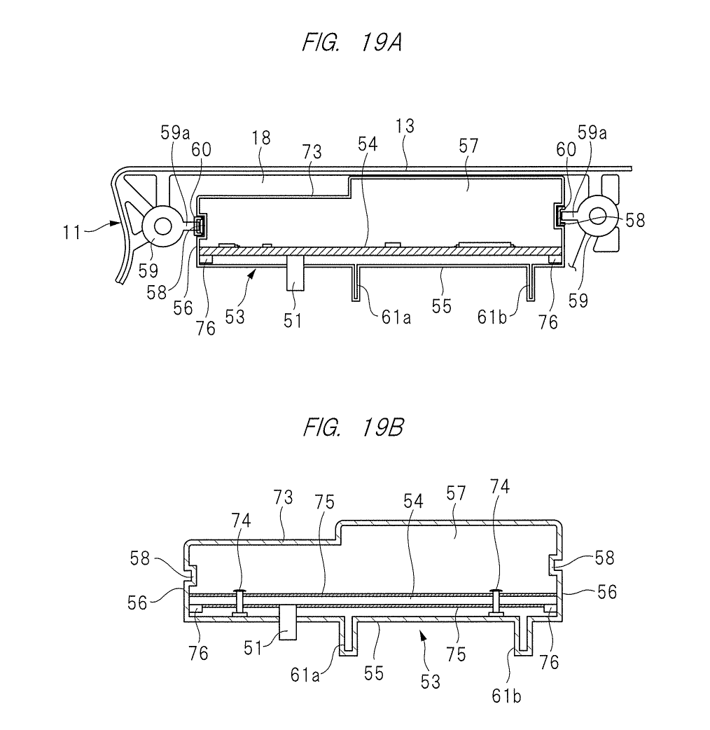

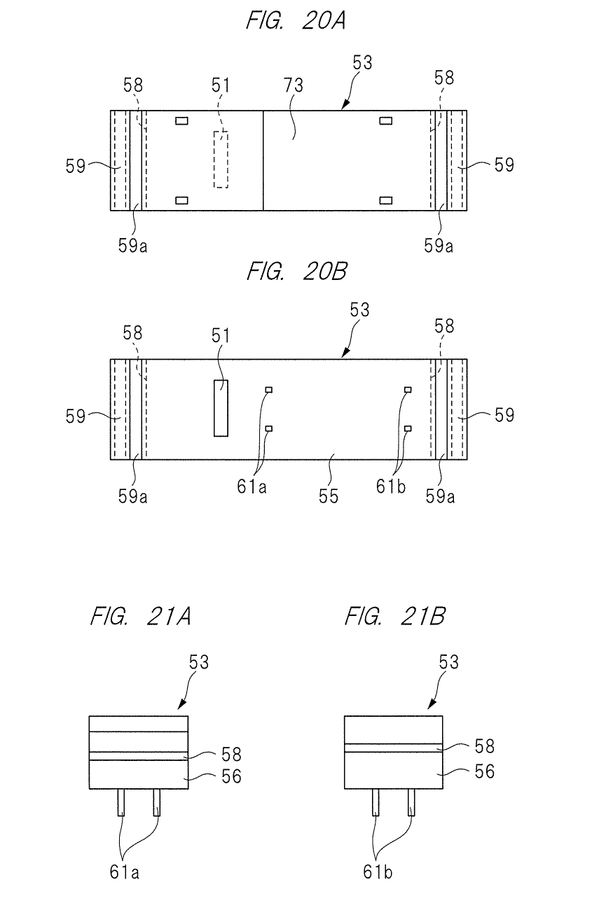

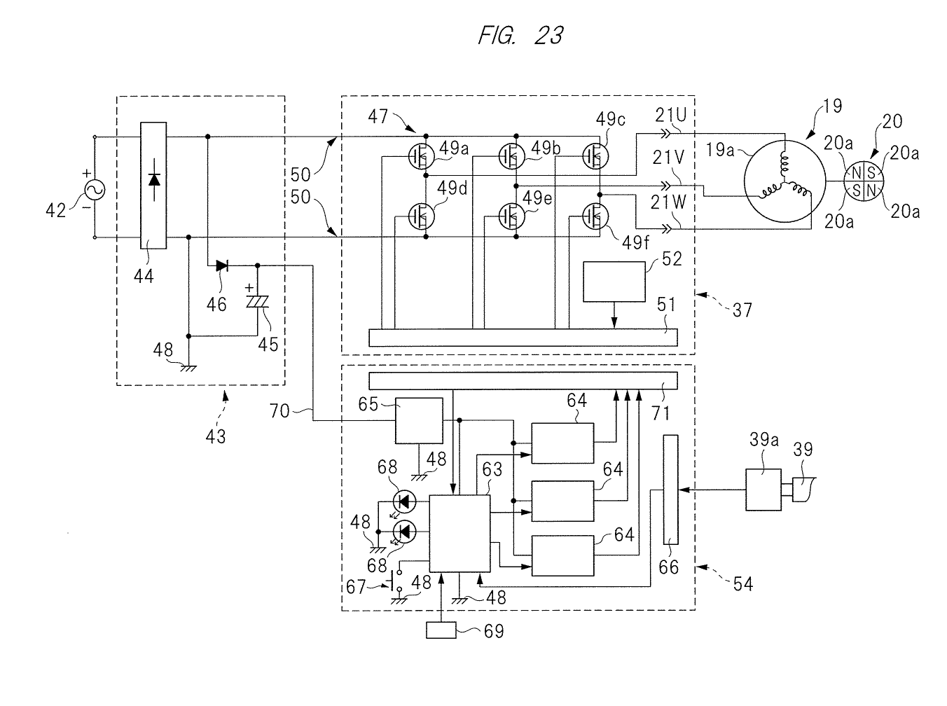

Hereinafter, a sixth embodiment of the present invention will be described in detail based on FIGS. 17 to 23. FIG. 17 shows a driver 110, which serves as an example of an electrical power tool. The driver 110 includes a housing 111 serving as a device main body molded from a synthetic resin. The housing 111 includes a tubular body portion 113 in which an electrical motor 112 is accommodated, a grip 114 connected to the body portion 113, and a power supply cord connecting unit 115 connected to a side opposite to the body portion 113 in the grip 114.

An accommodation chamber 116 for accommodating the electrical motor 112, and an accommodation chamber 118 for accommodating a control unit 117 are provided in the body portion 113. An insulator 138 that partitions the accommodation chamber 116 and the accommodation chamber 118 is also provided. The insulator 138 is fixed in the housing 111, and the insulator 138 includes a partitioning portion 138b extended in a direction along a first axis line A1, and a tube portion 138a continued to the partitioning portion 138b. The accommodation chamber 116 and the accommodation chamber 118 are arranged so as to be next to each other in a length direction of the grip 114. The accommodation chamber 118 is arranged on an outer side of the electrical motor 112 in the radial direction centering the first axis line A1. The accommodation chamber 118 is arranged on the side opposite to the grip 114 across the first axis line A1.

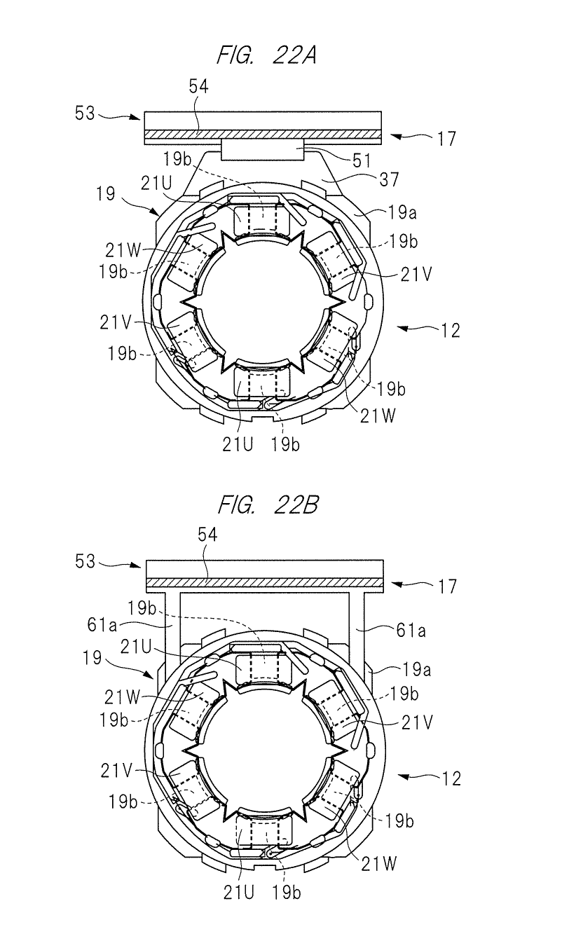

The electrical motor 112 is a brushless motor, and the electrical motor 112 includes a stator 119 fixed to the body portion 113, and a rotatable rotor 120. The stator 119 includes a tubular stator core 119a made from a magnetic material. As shown in FIG. 22, the stator 119 includes six teeth 119b provided on the inner side of the stator core 119a, and a plurality of, or specifically, three coils 121U, 121V, 121W wound around each of the six teeth 119b. The six teeth 119b are arranged at an interval of 60 degrees in the circumferential direction centering the first axis line A1. The coils 121U, 121V, 121W are wound around the different teeth 119b from each other. The coil 121U is wound around two teeth 119b arranged at an interval of 180 degrees, the coil 121V is wound around two teeth 119b arranged at an interval of 180 degrees, and the coil 121W is wound around two teeth 119b arranged at an interval of 180 degrees.

Four permanent magnets 120a are attached to an outer circumferential surface of the rotor 120. The shown electrical motor 112 is a brushless motor with three phases and four poles. The four permanent magnets 120a have the N pole and the S pole alternately arranged in the circumferential direction. The rotor 120 is fixed to an outer circumferential surface of the output shaft 122, and the rotor 120 integrally rotates with the output shaft 122 so as to center the first axis line A1. The rotation direction of the output shaft 122 can be switched between forward rotation and reverse rotation.

In the body portion 113, a partition wall 123 is fixed on the side opposite to the grip 114 in the direction along the first axis line A1. A gear cover 124 is attached to the partition wall 123, and a tubular cover 125 is attached to the gear cover 124. A bearing 126a is arranged in the tube portion 138a. A bearing 126b is provided in an axis hole of the partition wall 123. The output shaft 122 is rotatably supported by two bearings 126a, 126b. A cooling fan 127 is provided between the electrical motor 112 and the gear cover 124 in the accommodation chamber 116. The cooling fan 127 is fixed to the output shaft 122, so that the cooling fan 127 rotates with the output shaft 122.

The partition wall 123 includes an axis hole, and the output shaft 122 is inserted into the axis hole so that a part of the output shaft 122 is arranged inside the gear cover 124. A drive gear 128 is provided on an outer circumferential surface of a portion arranged in the gear cover 124 in the output shaft 122. Furthermore, a shaft 129 is provided in the gear cover 124, and the shaft 129 is rotatably supported by a bearing 130 centering a second axis line B1. The shaft 129 does not move in the direction along the second axis line B1.

A driven gear 131 that integrally rotates with the shaft 129 is provided, and the driven gear 131 meshes with the drive gear 128. A number of teeth of the driven gear 131 is larger than a number of teeth of the drive gear 128, and therefore, when the torque of the output shaft 122 is transmitted to the shaft 129, a rotation speed of the shaft 129 becomes lower than a rotation speed of the output shaft 122. In other words, the drive gear 128 and the driven gear 131 configure a speed reducing mechanism.

A part of an arrangement region of the driven gear 131 and a part of an arrangement region of the control unit 117 are overlapped with each other within a plane perpendicular to the first axis line A1. In specific explanation, a part of the arrangement region of the driven gear 131 and a part of the arrangement region of a control substrate 154 are overlapped with each other in a radial direction and a circumferential direction centering the first axis line A1. Furthermore, a part of the arrangement region of the driven gear 131 and a part of the arrangement region of the electrical motor 112 are overlapped with within a plane perpendicular to the first axis line A1.

A spindle 132 is provided from the inside of the gear cover 124 to the inside of the cover 125. The spindle 132 includes a concave portion 132a centering a second axis line B1, and one end of the shaft 129 is arranged in the concave portion 132a. The spindle 132 and the shaft 129 are relatively rotatable with each other so as to center the second axis line B1. The spindle 132 is movable in a direction along the second axis line B1. The driven gear 131, the spindle 132, and the shaft 129 are concentrically arranged. An outer diameter of the driven gear 131 is larger than an outer diameter of the spindle 132.

A clutch mechanism 133 for connecting or disconnecting a power transmission path between the driven gear 131 and the spindle 132 is provided. The clutch mechanism 133 is provided in the gear cover 124, and the clutch mechanism 133 includes a movable member 134 arranged between the driven gear 131 and the spindle 132. The movable member 134 is attached to the shaft 129, and the movable member 134 is movable in the direction along the second axis line B1 with respect to the shaft 129. The movable member 134 includes a first meshing portion. The clutch mechanism 133 includes a second meshing portion provided on the opposite side of the driven gear 131 to the bearing 130.

Furthermore, an elastic member 135 is provided between the driven gear 131 and the movable member 134. The elastic member 135 is a metallic compression spring. The movable member 134 is pressed against the spindle 132 by the force of the elastic member 135, so that the movable member 134 and the spindle 132 engage with each other, and the torque of the movable member 134 is transmitted to the spindle 132.

The second axis line B1 and the first axis line A1 are parallel to each other and are decentered. A distal end tool 136 is held by the spindle 132. The distal end tool 136 shown in FIG. 17 is a driver bit, and is used to tighten or loosen the screw member.

An element that controls the drive and stop of the electrical motor 112 will be described with reference to FIGS. 17, 18, and 23. An FET substrate 137 is provided in the accommodation chamber 116. The FET substrate 137 is extended in the direction intersecting the first axis line A1. The FET substrate 137 is fixed to the stator 119 so as not to rotate, and the output shaft 122 is arranged in an axis hole 137a formed in the FET substrate 137. The arrangement position of the FET substrate 137 is outside the arrangement range of the stator 119 in the direction along the first axis line A1, which is the center of rotation of the output shaft 122. The FET substrate 137 is arranged between the bearing 126a and the stator 119 in the direction along the first axis line A1.

A trigger 139 is provided in the grip 114, and the trigger 139 operates when operated by an operator. The electrical motor 112 is arranged between the grip 114 and the control unit 117 in the front view of the driver 110. A trigger switch 140 is provided in the grip 114. The trigger switch 140 detects an operation state of the trigger 139 and outputs a detection signal. One end of a power supply cord 141 is connected to the power supply cord connecting unit 115, and a plug provided at the other end of the power supply cord 141 is attachable to an alternating-current power supply 142. The alternating-current power supply 142 is, for example, an alternating-current 100-V power supply. A power supply substrate 143 is provided in the power supply cord connecting unit 115.

A rectifying circuit 144, a film capacitor 145, and a diode 146 are provided in the power supply substrate 143. The rectifying circuit 144 is a diode bridge obtained by combining publicly-known four diodes, and the rectifying circuit 144 is used to rectify the alternating-current power supply 142 to the direct current. The film capacitor 145 and the diode 146 are connected in series to each other, and the end of the diode 146 on the side opposite to the film capacitor 145 is connected between the rectifying circuit 144 and an inverter circuit 147 provided on the FET substrate 137. The end of the film capacitor 145 on the side opposite to the diode 146 is connected in parallel to a ground 148 and the rectifying circuit 144.

The arrangement position of the FET substrate 137 is within the arrangement range of the control unit 117 in the direction along the first axis line A1. A plurality of, specifically, six switching elements 149a to 149f are attached to the FET substrate 137, and the inverter circuit 147 is configured by six switching elements 149a to 149f. The six switching elements 149a to 149f are attached on one surface of the FET substrate 137 in the direction along the first axis line A1, and the switching elements 149a to 149f are protruded from the FET substrate 137 toward the bearing 126a.

As the six switching elements 149a to 149f, for example, the FET (Field Effect Transistor) is used. Two switching elements 19a and 149d among the six switching elements 149a to 149f are connected in parallel to the coil 121U corresponding to the U phase, the two switching elements 149b, 149e are connected in parallel to the coil 121V for the V phase, and the two switching elements 149c, 149f are connected in parallel to the coil 121W for the W phase.

Each of the switching elements 149a to 149c is connected in parallel to a positive electrode (+) of the alternating-current power supply 142 through the rectifying circuit 144, and each of the switching elements 149d to 149f is connected in parallel to a negative electrode (−) of the alternating-current power supply 142 through the rectifying circuit 144. The rectifying circuit 144 and the inverter circuit 147 are connected to each other by a lead wire 150. Furthermore, in the FET substrate 137, a substrate connector 151 is provided at the end on the accommodation chamber 118 side. The substrate connector 151 is extended in a direction orthogonal to the first axis line A1 in the front view of the driver 110. A plurality of, for example 18 to 20 terminals are attached to the substrate connector 151. The plurality of terminals are arranged along the direction orthogonal to the first axis line A1 in the plan view of the driver 110. Each gate of the six switching elements 149a to 149f is connected independently to the terminal provided on the substrate connector 151.

Furthermore, a rotor position detection element 152 for detecting a rotation position of the rotor 120 is provided on the FET substrate 137. The rotor position detection element 152 is configured by three Hall ICs, and the three Hall ICs detect the change in magnetic field generated by the four permanent magnets 120a, and each of the three Hall ICs outputs a detection signal in accordance with the rotation of the rotor 120. The rotor position detection element 152 is connected to a terminal provided on the substrate connector 151.

The configuration of the control unit 117 will be described with reference to FIGS. 17 to 22. An accommodation case 153 provided in the body portion 113 and the control substrate 154 accommodated in the accommodation case 153 are provided. The arrangement range of the control unit 117 and the arrangement range of the electrical motor 112 are partially overlapped with each other in the direction along the first axis line A1. The accommodation case 153 is made from a synthetic resin, and the accommodation case 153 includes a first plate member 173 and a second plate member 155 next to each other in parallel, and connection plates 156, 157 connecting the first plate member 173 and the second plate member 155.

The first plate member 173 and the second plate member 155 are both rectangular when the accommodation case 153 is seen in a plan view. A long side of each of the first plate member 173 and the second plate member 155 is arranged in the direction along the first axis line A1 when the accommodation case 153 is seen in the plan view. The connection plate 156 connects a short side of the first plate member 173 and a short side of the second plate member 155. The connection plate 157 connects the long side of the first plate member 173 and the long side of the second plate member 155. A plurality of ribs 176 are provided in the accommodation case 153, the control substrate 154 is positioned by being brought into contact with the ribs 176, and the control substrate 154 is fixed by a screw member 174 in the accommodation case 153. Note that both surfaces of the control substrate 154 are covered by a covering layer 175. The covering layer 175 is an electrical insulating material, and the control substrate 154 is sealed by the covering layer 175.

As the covering layer 175, for example, urethane can be used. The urethane is a chemical compound obtained by dehydration of an amino group and an alcohol group via a carbonyl group. Note that the urethane also includes chemical compounds which are idiomatically-called urethane such as ethyl carbamate and polyurethane.

Two connection plates 156 are arranged in parallel to each other, and the two connection plates 156 are bent toward the accommodation case 153 so as to provide grooves 158 thereon, respectively. The two grooves 158 are arranged at different positions from each other in the direction along the first axis line A1. Meanwhile, two supporting pieces 159 are provided on the inner surface of the body portion 113. The two supporting pieces 159 are arranged at different positions from each other in the direction along the first axis line A1. The accommodation case 153 is arranged between the two supporting pieces 159 in the direction along the first axis line A1. The two supporting pieces 159 are molded from a synthetic resin, and are fixed to the body portion 113. The two supporting pieces 159 are arranged within the arrangement range of the two connection plates 156 in a radial direction centering the first axis line A1.

A rib 159a is provided in each of the two supporting pieces 159. The two ribs 159a are protruded in the direction of approaching the two connection plates 156. Each of the two ribs 159a are separately inserted into each of the two grooves 158. An elastic body 160 is interposed between the rib 159a and the inner surface of the groove 158. The elastic body 160 is integrally molded by a synthetic rubber, an elastomer, or others. The accommodation case 153 is supported by the body portion 113 through the two supporting pieces 159.

A plurality of, specifically, two connecting units 161a, 161b are arranged on the outer surface of the second plate member 155 in the accommodation case 153. The connecting unit 161a and the connecting unit 161b are arranged at different positions from each other in the direction along the first axis line A1. The two connecting units 161a, 161b are arranged between the two supporting pieces 159 in the direction along the first axis line A1. The two connecting units 161a, 161b are protruded from the outer surface of the second plate member 155 in the direction of approaching the first axis line A1.

Two connecting units 161a are provided, and two latch units 161 are provided. When the accommodation case 153 is seen in the plan view, the two connecting units 161a are arranged with an interval in the direction intersecting the first axis line A1. When the accommodation case 153 is seen in the plan view, the two connecting units 161b are arranged with an interval in the direction intersecting the first axis line A1.

A plurality of holes 162a, 162b are formed in the partitioning portion 138b. The plurality of holes 162a, 162b are arranged with an interval in the direction along the first axis line A1. Two holes 162a are provided, and two holes 162b are provided. The connecting unit 161a is inserted to the hole 162a, and the connecting unit 161b is inserted to the hole 162b. The ends of the connecting units 161a, 161b are positioned within the accommodation chamber 116, and the connecting units 161a, 161b are arranged on both sides of the stator core 119a in the direction along the first axis line A1.

That is, the stator core 119a is sandwiched by the two connecting units 161a, 161b. In such a configuration as fixing the FET substrate 137 to the electrical motor 112, the control substrate 154 is fixed to the stator core 119a of the electrical motor 112 by the connecting units 161a, 161b. Thus, the substrate connectors 151, 171 are suppressed from being detached due to integral vibration of the two substrates 137, 154 when the electrical motor 112 is vibrated.

The control substrate 154 includes a microcomputer 163, a plurality of drive signal output circuits 164, a regulator 165, and a switch operation detection circuit 166. The microcomputer 163 includes a central processing unit that controls the inverter circuit 147 based on the processing program and the data, a ROM in which the processing program and the control data are stored, and a RAM for temporarily storing the data. The microcomputer 163 is connected to the plurality of drive signal output circuits 164 and the switch operation detection circuit 166. The control signal output from the microcomputer 163 is input to each of the plurality of drive signal output circuits 164. The detection signal output from the trigger switch 140 is input to the switch operation detection circuit 166, and the switch operation detection circuit 166 detects the operation amount of the trigger 139. The signal output from the switch operation detection circuit 166 is input to the microcomputer 163. In the microcomputer 163, a target rotation number of the output shaft 122 is determined based on the signal input from the switch operation detection circuit 166.

Furthermore, a strong/weak switch 167 is provided on the substrate 154, and the strong/weak switch 167 is connected to the microcomputer 163 and the ground 148. Two strong/weak switching display LEDs 168 are provided on the substrate 154, and the two strong/weak switching display LEDs 168 are arranged in parallel to each other between the microcomputer 163 and the ground 148.

For example, in the case of the driver, a pulling amount of the trigger 139 is limited to be smaller than the maximum value if the strong/weak switch 67 is set to “weak”, and the pulling amount of the trigger 139 can be maximized if the strong/weak switch 167 is set to “strong”. Thus, the rotation number of the electrical motor 112 is limited if the pulling amount of the trigger 139 is limited.

In the case of the impact tool, a set value of the torque of the electrical motor 112 can be switched to “strong” or “weak” by switching the setting of the strong/weak switch 167. The microcomputer 163 controls a duty ratio of the six switching elements 149a to 149f by a signal from the strong/weak switch 167 to change the rotation number. The two strong/weak switching display LEDs display “strong” or “weak” of the set torque.

The trigger 139 activates/stops the driver 110, and, when the operator turns the trigger 139 ON, the voltage of the alternating-current power supply 142 is applied to the microcomputer 163 and the drive signal output circuit 164. Furthermore, a rotation direction switch 169 is provided in the housing 111, and an operation signal of the rotation direction switch 169 is input to the microcomputer 163. The rotation direction switch 169 is operated by the operator to switch the rotation direction of the distal end tool 136, that is, the rotation direction of the output shaft 122 of the electrical motor 112.

One end of the regulator 165 is connected in parallel to the diode 146 and the film capacitor 145 through the lead wire 170, and the other end of the regulator 165 is connected to the microcomputer 163 and each of the plurality of drive signal output circuits 164. The lead wires 150, 170 are arranged in the grip 114. The regulator 165 drops the output voltage of the alternating-current power supply 142 and makes the voltage constant, and supplies the output voltage to the microcomputer 163 and the plurality of drive signal output circuits 164. The plurality of drive signal output circuits 164 are configured by a plurality of, specifically, three driver ICs corresponding to the U phase, the V phase, and the W phase.

The plurality of drive signal output circuits 164 output a drive signal, that is, a PWM signal for individually controlling the timing to turn ON/OFF the six switching elements 149a to 149f, the duty ratio which is the ON ratio, and others in accordance with the control signal input from the microcomputer 163. The PWM signal is an abbreviation for the Pulse Width Modulation signal, and means a pulse width modulation signal.

The substrate connector 171 is provided on the control substrate 154. The substrate connector 171 is extended in the direction orthogonal to the first axis line A1 when the driver 110 is seen in the plan view. A plurality of, for example, 18 to 20 terminals are attached to the substrate connector 171. The plurality of terminals are arranged along the direction orthogonal to the first axis line A1 when the driver 110 is seen in the plan view. The substrate connector 171 is engaged and connected to the substrate connector 151. That is, the plurality of terminals provided on the substrate connector 171 and the plurality of terminals provided on the substrate connector 151 are separately connected to each other.

The terminals connected to the six switching elements 149a to 149f through the substrate connector 151 among the plurality of terminals provided on the substrate connector 171 are separately connected to the three drive signal output circuits 164. The terminals connected to the rotor position detection element 152 through the substrate connector 151 among the plurality of terminals provided on the substrate connector 171 are connected to the microcomputer 163. The microcomputer 163 obtains the power-supply direction, the power-supply timing, the power-supply time, and the duty ratio for the three coils 121U, 121V, and 121W based on the signal input from the rotor position detection element 152 and the stored data, and outputs the control signal to each of the three drive signal output circuits 164.

In the present embodiment, when the trigger 139 is operated, the microcomputer 162 outputs the control signal based on the position detection signal of the rotor position detection element 152 to each of the three drive signal output circuits 164.

The three drive signal output circuits 164 output the drive signal to the gates of the six switching elements 149a to 149f based on the control signal input from the microcomputer 163. That is, the six switching elements 149a to 149f are separately turned ON/OFF by the drive signal.

According to this control, the power is alternately supplied to each of the three coils 121U, 121V, 121W in a predetermined power-supply direction, a predetermined power-supply timing, and a predetermined time, so that the rotor 120 and the output shaft 122 are integrally rotated. Specifically, the voltage, the current, and the duty ratio applied on the three coils 121U, 121V, 121W are controlled so that the practical rotation number of the output shaft 122 approaches the target rotation number. The practical rotation number of the output shaft 122 is detected from the signal of the rotor position detection element 152. The torque of the output shaft 122 is transmitted to the driven gear 131 through the drive gear 128. Here, if the distal end tool 136 is not pressed against the screw member which is the object, the first meshing portion and the second meshing portion are separated from each other by the force of the elastic member 135. That is, the clutch mechanism 133 is released. Thus, the torque of the driven gear 131 is not transmitted to the spindle 132.

On the other hand, if the distal end tool 136 is pressed against the screw member, the spindle 132 moves in the direction of approaching the driven gear against the force of the elastic member 135, and the first meshing portion and the second meshing portion are meshed with each other. That is, the clutch mechanism 133 is engaged. Thus, the torque of the driven gear 131 is transmitted to the distal end tool 136 through the spindle 132, so that the work of tightening the screw member or loosening the screw member is performed. When the operator operates the rotation direction switch 169, note that the direction of the current supplied to the three coils 121U, 121V, 121W can be switched, and the rotation direction of the distal end tool 136 can be changed. However, even if the main switch 167 is turned ON, the voltage is not applied to the three coils 121U, 121V, 121W unless the trigger 139 is operated, and the torque is not output from the output shaft 122.

In the driver 110 of the present embodiment, the housing 111 is divided in half along a dividing plane including the first axis line A1 and the second axis line B1 over the body portion 113, the grip 114, and the power supply cord connecting unit 115, and the two divided bodies are assembled so as to be fixed with the screw member. In the assembly step of the driver 110, the electrical motor 112, the FET substrate 137, the control substrate 154, and the power supply substrate 143 are attached to the first divided body, and the second divided body overlays on the first divided body.

When the control substrate 154 and the FET substrate 137 are attached to the body portion 113, the substrate connector 151 and the substrate connector 171 are engaged and connected with each other. The connecting direction of the substrate connector 151 and the substrate connector 171 is the direction orthogonal to the first axis line A1 when the driver 110 shown in FIG. 17 is seen in the side view. The substrate connectors 151, 171 are both connected while being inserted to the hole 172 of the partitioning portion 138b. Thus, when the electrical motor 112 is vibrated in the direction along the first axis line A1, occurrence of stress, that is, concentration of stress at the connecting portion between the substrate connector 151 and the substrate connector 171 can be suppressed.

Furthermore, the accommodation case 153 is supported by the body portion 113 of the housing 111 through the supporting piece 159, and the stator core 119a is attached to the housing 111 through the insulator 138. Thus, when the vibration of the electrical motor 112 is transmitted to the housing 111, the FET substrate 137 and the control substrate 154 are integrally vibrated with each other in the direction along the first axis line A1. Therefore, the substrate connector 151 and the substrate connector 171 can be suppressed from being detached.

The FET substrate 137 and the control substrate 154 are connected to each other by the two substrate connectors 151, 171, and the lead wire is not used. Therefore, the number of the lead wire provided in the grip 114 can be reduced, and the structure of the driver 110 can be simplified. Furthermore, increase in the number of components of the driver 110 can be suppressed, the assembly workability of the driver 110 can be enhanced, and increase in the manufacturing cost of the driver 110 can be suppressed.

Furthermore, the waterproof property is enhanced since the control substrate 154 is accommodated in the accommodation case 153. Moreover, in the assembly step of the driver 110, the accommodation case 153 accommodating the control substrate 154 is attached to the housing 111, the connecting unit 161a is inserted to the hole 162a, and the connecting unit 161b is inserted to the hole 162b. Then, the stator core 119a is inserted between the connecting units 161a, 161b when the electrical motor 112 is attached to the housing 111, so that the accommodation case 153 is positioned in the direction along the first axis line A1 with respect to the electrical motor 112.

That is, the substrate connector 151 and the substrate connector 171 are positioned in the direction along the first axis line A1. Therefore, the work of positioning the substrate connector 151 and the substrate connector 171 in the direction along the first axis line A1 is facilitated, and the assembly workability of the driver 110 is enhanced.

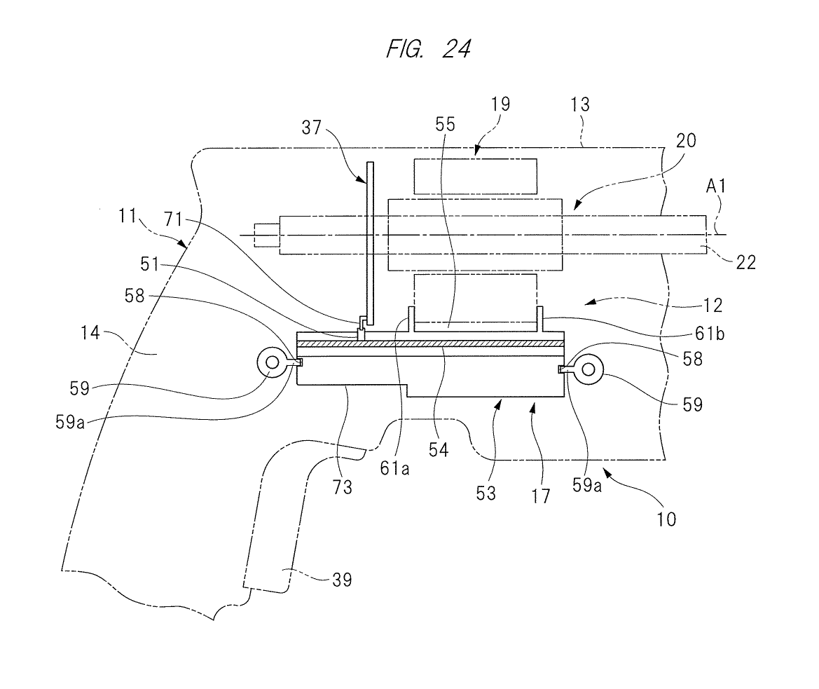

Furthermore, another arrangement position of the control unit 117 will be described based on FIG. 24. The control unit 117 is arranged between the electrical motor 112 and the trigger 139 when the driver 110 is seen in the front view. The control unit may be arranged between the trigger and the electrical motor in the drill motor housing. The control unit 117 includes the accommodation case 153 and the control substrate 154 accommodated in the accommodation case 153. A part of the stator 119 is arranged between the connecting unit 161a and the connecting unit 161b in the direction along the first axis line A1 when the driver 110 is seen in the front view. Furthermore, the substrate connector 151 provided on the control substrate 154 and the substrate connector 171 provided on the FET substrate 137 are directly connected. The driver 110 shown in FIG. 24 can connect the control substrate 154 and the FET substrate 137 without using the lead wire, and can obtains effects similar to those of the driver 110 shown in FIG. 17.

In the explanation of the correspondence relation between the configuration described in the present embodiment and the configuration of the present invention, the driver 110 corresponds to an electrical power tool of the present invention, the switching elements 149a to 149f correspond to electrical components of the present invention, the substrate connector 171 corresponds to a first connector of the present invention, the FET substrate 137 corresponds to a first substrate of the present invention, the microcomputer 163 and the drive signal output circuit 164 correspond to a control circuit of the present invention, and the second substrate including the second connector and the substrate connector 151 correspond to a second connector of the present invention. Furthermore, the accommodation case 153 corresponds to a case of the present invention, the connecting units 161a, 161b correspond to a connecting unit of the present invention, the spindle 132 corresponds to a tool holding member of the present invention, and the driven gear 131 corresponds to a torque transmitting member of the present invention.

The present invention is not limited to the foregoing embodiments and various modifications can be made within the scope of the present invention. For example, the electrical motor is not limited to a three phase brushless motor, and may be a reluctance motor in which the permanent magnet is not provided on the rotor. The electrical motor may be a motor with a brush. Furthermore, the electrical power tool includes a tool that supplies a direct-current power supply, for example, power of a secondary battery to the electrical motor. The secondary battery can be charged and discharged, and the secondary battery includes a battery and a capacitor.

In the direction along the first axis line A1, the FET substrate 137 may be arranged between the electrical motor 112 and the bearing 126b, and the cooling fan 127 may be arranged between the electrical motor 112 and the bearing 126a. In other words, the FET substrate 137 and the cooling fan 127 may be inversely arranged in FIG. 17 or FIG. 24. Not the substrate on which the FET is mounted but the sensor substrate provided with the rotor position detection element 152 for detecting the rotation position of the rotor 120 and the control substrate 154 may be connected. Also in this case, the lead wire for connecting the rotor position detection element 152 and the control substrate 154 can be shortened. Note that the lead wire for connecting the FET and the control substrate 154 can be shortened as much as possible by providing the FET on the control substrate 154.

The electrical power tool of the present invention includes not only the driver but also a drill for making a hole in the object by rotating the distal end tool, a hammer driver and a hammer drill for applying a rotation force and a striking force in the direction along the second axis line onto the distal end tool. In other words, the distal end tool includes the driver bit in addition to a drill bit. The electrical power tool of the present invention includes not only the tool in which the distal end tool is directly attachable to the tool holding member but also a tool in which the distal end tool is attachable to the tool holding member through an intermediate member such as an adapter, an extension bar, a socket, and others. Furthermore, the electrical power tool of the present invention includes a tool in which the first axis line which is the center of rotation of the output shaft of the electrical motor and the second axis line which is the center of rotation of the tool holding member are concentrically arranged.

The electrical power tool of the present invention includes a hammer, a nail driving machine, and others which converts the rotating motion of the electrical motor to the reciprocating motion of the distal end tool. The electrical power tool of the present invention includes a grinder, a sander, and others which transmits the power of the electrical motor to the distal end tool, and cuts, polishes, and grinds the object.

The first connector and the second connector in the present invention are molded from a synthetic resin, and the rigidity of the first connector and the second connector is higher than the rigidity of the lead wire. That is, the first connector and the second connector may elastically deform but not bend as seen in the lead wire.

In the present invention, the engagement structure of the first connector and the second connector includes fitting, latching, and engaging. That is, the engagement structure includes a structure in which the first connector and the second connector are engaged with each other by a frictional force or an engagement force at the contacting portion between the first connector and the second connector. In other words, the latch structure of the first connector and the second connector includes a structure in which the first connector and the second connector are connected to each other by the fitting force generated by fitting one of either the first connector and the second connector having a tubular shape into the other tubular connector.

The latch structure of the first connector and the second connector includes a structure in which the first connector and the second connector are connected to each other by the engagement force generated by inserting a latch nail provided on either one of the first connector and the second connector into a latch hole provided on the other. The latch structure of the first connector and the second connector also includes a structure in which the first connector and the second connector are engaged with each other by providing a concave portion and a convex portion on at least one of the first connector and the second connector and elastically deforming the concave portion or the convex portion.

Moreover, the latch structure of the first connector and the second connector includes a structure in which the first connector and the second connector are connected to each other by a frictional force at the contacting portion between the terminal provided on the first connector and the terminal provided on the second connector. As described above, the shapes and the connecting structure of the first connector and the second connector are not limited.

The electrical components in the present invention are elements that configure a part of the electrical circuit from the power supply to the electrical motor. In the present invention, the phrase of “the control of the power to be supplied to the electrical motor” includes meaning of the control of the voltage, the current, the duty ratio, and others of the power to be supplied to the electrical motor.

The first substrate and the second substrate in the present invention include a printed substrate (board). The printed board is a main component of an electrical product used for fixing and wiring the electronic component. The printed board includes a rigid substrate, a flexible substrate, and others. The printed board also includes a paper phenol substrate, a paper epoxy substrate, a glass composite substrate, and others. The printed board may also be a one-sided substrate, a double-sided substrate, a multi-layered substrate, and others.

Furthermore, the torque transmitting member in the present invention includes a gear, a pulley, a sprocket, a belt, a speed reducing mechanism, and others. Further, the elastic body 160 in the present embodiment may be fixed to either the accommodation case 153 or the rib 159a. Still further, the driver 110 may include not the trigger 139 but a target rotation number setting unit. The target rotation number setting unit includes a target rotation number setting dial, a touch switch, and others provided in the housing 111. The operator operates the target rotation number setting unit, so that the target rotation number of the output shaft 122 of the electrical motor 112 can be set.

### INDUSTRIAL APPLICABILITY

The present invention can be used in an electrical power tool for transmitting the power of the electrical motor to the work tool through the power transmitting member.

1. An electrical power tool which drives a work tool with a power of an electrical motor comprising:
a device main body in which the electrical motor is provided;
a power transmitting mechanism which is arranged eccentrically with respect to an output shaft of the electrical motor and which transmits power of the output shaft to the work tool; and
an electrical component arranged inside the device main body,
wherein an arrangement region of the power transmitting mechanism and an arrangement region of the electrical component are at least partially overlapped with each other in a circumferential direction centering the output shaft.

2. The electrical power tool according to claim 1,
wherein the arrangement region of the power transmitting mechanism and the arrangement region of the electrical component are at least partially overlapped with each other in a radial direction centering the output shaft.

3. The electrical power tool according to claim 1,
wherein a vent hole through which air entering from outside of the device main body to inside of the device main body passes is provided in the device main body.

4. The electrical power tool according to claim 3,
wherein a first accommodation chamber for arranging the electrical component is provided inside the device main body, and
the vent hole is provided on an outer wall of the first accommodation chamber.

5. The electrical power tool according to claim 1,
wherein the device main body includes:
a motor housing for accommodating the electrical motor;
a first connecting unit and a second connecting unit provided so as to be next to each other with respect to the motor housing; and
a grip which is connected to the first connecting unit and the second connecting unit, and
the electrical component includes a power supply circuit for supplying power to the electrical motor.

6. The electrical power tool according to claim 5,
wherein a control circuit for controlling the power supplied from the power supply circuit to the electrical motor is provided in the first connecting unit.

7. The electrical power tool according to claim 6,
wherein an end of a power supply cord is attached to the grip,
a power supply cable which connects the power supply cord and the power supply circuit is arranged over the grip and the second connecting unit, and
a control circuit power supply cable which connects the power supply circuit and the control circuit is arranged in the second connecting unit and the grip.

8. The electrical power tool according to claim 1,
wherein the device main body includes:
a motor housing for accommodating the electrical motor;
a first connecting unit and a second connecting unit provided so as to be next to each other with respect to the motor housing; and
a grip which is connected to the first connecting unit and the second connecting unit,
a power supply circuit which supplies power to the electrical motor is provided in the first connecting unit, and
the electrical component includes a control circuit for controlling the power supplied from the power supply circuit to the electrical motor.

9. The electrical power tool according to claim 8,
wherein an end of a power supply cord is attached to the grip,
a power supply cable which connects the power supply cord and the power supply circuit is arranged in the first connecting unit, and
a control circuit power supply cable which connects the power supply circuit and the control circuit is arranged in the grip and the second connecting unit.

10. The electrical power tool according to claim 5,
wherein a control circuit for controlling the power supplied from the power supply circuit to the electrical motor is arranged on a side opposite to the power supply circuit across the electrical motor.

11. The electrical power tool according to claim 10,
wherein an end of a power supply cord is attached to the grip,
a power supply cable which connects the power supply cord and the power supply circuit is arranged in the grip and the second connecting unit, and
a control circuit power supply cable which connects the power supply circuit and the control circuit is arranged in the second connecting unit, the grip, and the first connecting unit.

12. The electrical power tool according to claim 1,
wherein the device main body includes:
a motor housing for accommodating the electrical motor; and
a grip which is continued to the motor housing and which forms the device main body into an L-shape with the motor housing,
the electrical component includes a power supply circuit for supplying power to the electrical motor, and
a control circuit for controlling the power supplied from the power supply circuit to the electrical motor is arranged on a side opposite to the power supply circuit across the electrical motor.

13. The electrical power tool according to claim 12,
wherein an end of a power supply cord is attached to the grip,
a power supply cable which is arranged in the grip and which connects the power supply cord and the power supply circuit is provided, and
a control circuit power supply cable which is arranged in the grip and which connects the power supply circuit and the control circuit is provided.

14. The electrical power tool according to claim 6,
wherein an arrangement region of the power supply circuit and an arrangement region of the electrical motor are at least partially overlapped with each other in a direction along the output shaft.

15. The electrical power tool according to claim 8,
wherein an arrangement region of the power supply circuit and an arrangement region of the electrical motor are at least partially overlapped in a direction along the output shaft.

16. The electrical power tool according to claim 3, further comprising:
a substrate including a switching element which controls the electrical motor,
wherein the vent hole includes a first vent hole through which air toward the substrate passes.

17. The electrical power tool according to claim 16,
wherein, inside the device main body,
a second accommodation chamber for arranging the electrical component is provided, and
a second vent hole which guides air passed through the first vent hole to the second accommodation chamber is provided.

18. The electrical power tool according to claim 17,
wherein the electrical motor is arranged in the second accommodation chamber, and the electrical motor is cooled by the air passed through the first vent hole and the second vent hole.

19. The electrical power tool according to claim 4,
wherein the first accommodation chamber is swelled to be an arc shape when seen in a cross-sectional view orthogonal to the output shaft,
the electrical component is provided on a substrate, and
the electrical component having a large amount of protrusion from the substrate is arranged at a most swelled position in the first accommodation chamber.

20. An electrical power tool which drives a work tool with a power of an electrical motor comprising:
a motor accommodation space in which the electrical motor is accommodated;
a first accommodation space which is positioned on an outer side in a radial direction of the electrical motor and which accommodates a power supply circuit;
a second accommodation space which is positioned on a side opposite to the first accommodation space in the radial direction of the electrical motor and which accommodates a control circuit for controlling the electrical motor;
a first wall unit which partitions the motor accommodation space and the first accommodation space; and
a second wall unit which partitions the motor accommodation space and the second accommodation space,
wherein at least one of a first connection hole which is formed in the first wall unit and which connects the motor accommodation space and the first accommodation space and a second connection hole which is formed in the second wall unit and which connects the motor accommodation space and the second accommodation space is provided.

21. The electrical power tool according to claim 20,
wherein only either one of the first connection hole and the second connection hole is provided.

22. The electrical power tool according to claim 20,
wherein a device main body which has the motor accommodation space, the first accommodation space, and the second accommodation space formed therein and which has the first wall unit and the second wall unit provided therein is provided, and
a vent hole provided in the device main body to connect inside and outside of the device main body is provided.

23. The electrical power tool according to claim 22,
wherein at least one of the first connection hole and the second connection hole is shifted from the vent hole in a direction of extension of the power supply circuit.

24. The electrical power tool according to claim 20,
wherein a switching element which supplies power to the electrical motor is arranged in the motor accommodation space.

25. The electrical power tool according to claim 20,
wherein a switching element which supplies power to the electrical motor is provided in the control circuit, and the first connection hole and the second connection hole are both provided.

26. The electrical power tool according to claim 25,
wherein a device main body which has the motor accommodation space, the first accommodation space, and the second accommodation space formed therein and which has the first wall unit and the second wall unit provided therein is provided, and
a vent hole provided in the device main body to connect inside and outside of the device main body is provided.

27. An electrical power tool which drives a work tool with a power of an electrical motor including a rotatable output shaft centering an axis line comprising:
a motor accommodation space in which the electrical motor is accommodated;
a substrate accommodation space which is positioned on an outer side of the electrical motor in a radial direction centering the axis line and which accommodates a circuit substrate controlling the electrical motor;
a device main body which has the motor accommodation space and the substrate accommodation space formed therein; and
a vent hole provided in the device main body to connect inside and outside of the device main body.

28. An electrical power tool which supplies a power to an electrical motor comprising:
a first substrate provided with an electrical component which controls the power to be supplied to the electrical motor;
a second substrate provided with a control circuit which controls the electrical component;
a first connector provided on the first substrate and connected to the electrical component; and
a second connector provided on the second substrate so as to be engaged and connected to the first connector and so as to be connected to the control circuit.

29. The electrical power tool according to claim 28,
wherein a case for accommodating the second substrate is provided.

30. The electrical power tool according to claim 29,
wherein a connecting unit which positions the case in the electrical motor is provided in the case.

31. The electrical power tool according to claim 28,
wherein a housing which accommodates the electrical motor and which supports the case is provided.

32. The electrical power tool according to according to claim 31,
wherein the case is supported by the housing through an elastic body.

33. The electrical power tool according to claim 28,
wherein the electrical motor includes a rotatable output shaft centering a first axis line,
the first substrate includes a shaft hole in which the output shaft is arranged, and
the second substrate is arranged on an outer side of the electrical motor in a radial direction centering the first axis line and is extended in parallel to the first axis line.

34. The electrical power tool according to claim 33,
wherein a torque transmitting member to which a torque of the output shaft is transmitted and which is rotatable centering a second axis line in parallel to the first axis line is provided,
a tool holding member to which a torque is transmitted from the torque transmitting member, which rotates around the second axis line as a center, and which supports a distal end tool is provided, and
an arrangement position of the second substrate and an arrangement position of the torque transmitting member are at least partially overlapped with each other in a circumferential direction and a radial direction of the output shaft.

35. An electrical power tool which supplies a power to an electrical motor comprising:
a first substrate provided with an electrical component which controls the power to be supplied to the electrical motor and which is attached to the electrical motor;
a second substrate including a control circuit for controlling the electrical component;
a first connector which is provided on the first substrate and which is connected to the electrical component;
a second connector which is provided on the second substrate and which is connected to the control circuit;
a case accommodating the second substrate; and
a connecting unit which is provided in the case and which positions the case in the electrical motor.

36. The electrical power tool according to claim 35,
wherein the first connector and the second connector are engaged and connected with each other.

37. The electrical power tool according to claim 35,
wherein a housing which accommodates the electrical motor and which supports the case is provided.

38. The electrical power tool according to claim 37,
wherein the case is supported by the housing through an elastic body.

39. The electrical power tool according to claim 35,
wherein the electrical motor includes a rotatable output shaft centering a first axis line;
the first substrate includes a shaft hole where the output shaft is arranged; and
the second substrate is arranged on an outer side of the electrical motor in a radial direction centering the first axis line and is extended in parallel to the first axis line.

40. The electrical power tool according to claim 39,
wherein a torque transmitting member to which a torque of the output shaft is transmitted and which is rotatable so as to center a second axis line in parallel to the first axis line is provided, and
a tool holding member to which a torque is transmitted from the torque transmitting member, which rotates so as to center the second axis line, and which supports a distal end tool is provided, and
an arrangement position of the second substrate and an arrangement position of the torque transmitting member are at least partially overlapped with each other in a circumferential direction and a radial direction of the output shaft.
